(19) United States
(12) Patent Application Publication
(10) Pub. No.: US 2005/0193211 A1
(43) Pub. Date: Sep. 1, 2005

(54) Management of user authentication information together with authentication level

(76) Inventor: Hiroyasu Kurose, Tokyo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/983,030

(22) Filed: Nov. 8, 2004

(30) Foreign Application Priority Data
Nov. 12, 2003 (JP) 2003-382760
Nov. 2, 2004 (JP) 2004-319692

(51) Int. Cl. H04L 9/00

(52) U.S. Cl. 713/185; 726/17

(57) ABSTRACT

An apparatus for providing an authentication service includes an authentication service providing unit. The authentication service providing unit includes an authentication level calculating unit configured to calculate an authentication level indicative of strength of authentication, and a user authentication information managing unit configured to manage user authentication information relating to user authentication associated with the authentication level calculated by the authentication level calculating unit.

### BACKGROUND OF THE INVENTION

1. Field of the Invention

The present invention generally relates to an authentication service providing apparatus, an Web service providing apparatus, a user terminal apparatus, an authentication service providing method, an Web service providing method, an Web service utilizing method, an authentication service providing program, an Web service providing program, an Web service utilizing program, and a record medium.

2. Description of the Related Art

In recent years, various authentication means have been available, including password-based authentication combining an account with a password, biometrical authentication using fingerprints, voiceprints, or the like, device-based authentication such as RFID (radio frequency identification), etc. These authentication means vary in terms of the strength of authentication.

In fingerprint authentication or the like, for example, a decision can be easily made as to whether a given fingerprint belongs to the user of a given account. It is difficult, however, to identify the person who has the fingerprint in question. This is because each fingerprint matching takes time, so that it takes a lengthy time to carry out fingerprint matching on all the users to identify the person having the fingerprint in question. Because of this, fingerprint authentication or the like has been generally used together with other authentication methods such as password-based authentication or the like. For example, password-based authentication is first performed to identify a user, followed by performing fingerprint authentication to double-check the authenticity of the identified user.

In this manner, a plurality of authentication means having the respective strengths of authentication may be combined to identify the user. In the related art, when there is a need to limit user access to documents in Web services such as document-management services, information about access rights is set and managed by associating respective authentication means with the documents. For example, a decision as to whether to grant an access right such as a Read right or a Read/Write right is made by performing a designated authentication or a combination of designated authentications with respect to each of the documents.

If information about access rights is set and managed by associating respective authentication means with the documents, however, extreme difficulties may arise due to the large volume of combinations. For example, the presence of n authentication means results in 2ⁿ combinations of authentication means. The information about access right thus needs to be controlled with respect to each document by taking into account the 2ⁿ combinations of authentication means having the respective, different strengths of authentication.

Moreover, if information about access rights is set and managed by associating respective authentication means with the documents, modification to the authentication means or the addition/removal of authentication means results in a problem. That is, the table for managing information about access rights needs to be modified or newly generated each time such modification or addition/removal is made.

Accordingly, there is a need for a scheme that can efficiently manage information about access rights regarding the objects provided by an Web service.

### SUMMARY OF THE INVENTION

It is a general object of the present invention to provide an apparatus and method that substantially obviate one or more problems caused by the limitations and disadvantages of the related art.

Features and advantages of the present invention will be presented in the description which follows, and in part will become apparent from the description and the accompanying drawings, or may be learned by practice of the invention according to the teachings provided in the description. Objects as well as other features and advantages of the present invention will be realized and attained by an apparatus and method particularly pointed out in the specification in such full, clear, concise, and exact terms as to enable a person having ordinary skill in the art to practice the invention.

To achieve these and other advantages in accordance with the purpose of the invention, the invention provides an apparatus for providing an authentication service, including an authentication service providing unit. The authentication service providing unit includes an authentication level calculating unit configured to calculate an authentication level indicative of strength of authentication, and a user authentication information managing unit configured to manage user authentication information relating to user authentication associated with the authentication level calculated by the authentication level calculating unit.

Further, the present invention provides an apparatus for providing a Web service including a Web service providing unit. The Web service providing unit includes an access-right managing unit configured to manage access-right management data that includes a user identifier indicative of a user, an authentication level indicative of strength of authentication, an object identifier indicative of an object provided by the Web service providing unit, and information about an access right regarding the object.

Further, the present invention provides a user terminal apparatus for utilizing a Web service, including a Web service utilizing unit. The Web service utilizing unit includes a user authentication information managing unit configured to manage one of user authentication information relating to user authentication and a user authentication information identifier indicative of the user authentication information, and a display unit configured to display an authentication result of the user authentication and/or an authentication level indicative of strength of authentication associated with the user authentication information.

Further, the present invention provides a method of providing an authentication service, including a user authentication request receiving step of receiving a user authentication request from an Web service utilizing unit that uses a Web service, a first authentication level calculating step of calculating an authentication level indicative of strength of authentication, and a user authentication information creating step of creating user authentication information relating to user authentication associated with the authentication level calculated by the first authentication level calculating step.

Further, the present invention provides a method of providing a Web service, including an access request receiving step of receiving a request for accessing an object from a Web service utilizing unit that uses the Web service, the request including an object identifier indicative of an object provided by a Web service providing unit and an access type indicative of a requested access type, a user identifier acquiring step of acquiring a user identifier indicative of a user, a first authentication level acquiring step of acquiring an authentication level indicative of strength of authentication, an access-right acquiring step of acquiring information about an access right regarding an object from access-right management data including the user identifier, the authentication level, the object identifier, the information about an access right regarding the object in response to in response to the object identifier, the user identifier, an authentication level indicative of strength of authentication, and an access checking step of checking based on the access type and the information about the access right acquired at the access-right acquiring step whether a requested document can be accessed.

Further, the present invention provides a method of utilizing a Web service, including a user authentication request transmitting step of transmitting a user authentication request to an authentication service providing unit that provides an authentication service, a user authentication information receiving step of receiving user authentication information relating to user authentication associated with an authentication level indicative of strength of authentication calculated by the authentication service providing unit or receiving a user authentication information identifier indicative of the user authentication information, and a user authentication result displaying step of displaying an authentication result of the user authentication.

With this provision, the present invention can effectively manage information about access rights regarding objects provided by a Web service.

### BRIEF DESCRIPTION OF THE DRAWINGS

Other objects and further features of the present invention will be apparent from the following detailed description when read in conjunction with the accompanying drawings;

FIG. 1 is a block diagram showing an example of the hardware construction of an authentication service providing server;

FIG. 2 is a block diagram showing an example of the hardware construction of a Web service providing server;

FIG. 3 is a block diagram showing an example of the hardware construction of a user terminal apparatus;

FIG. 4 is a sequence chart for explaining examples of an authentication service providing method, a Web service providing method, and a Web service utilizing method;

FIG. 5 is a block diagram showing an example of the functional configuration of an authentication service;

FIG. 6 is a functional block diagram showing an example of a document management service;

FIG. 7 is a functional block diagram showing an example of a client service;

FIG. 8 is a diagram for explaining an example of an authentication process performed by the authentication service;

FIG. 9 is a diagram for explaining an example of the process relating to additional authentication performed by the authentication service;

FIG. 10 is a diagram for explaining an example of the process relating to ticket decryption by the authentication service;

FIG. 11 is a diagram for explaining an example of the process relating to the commencement of a session performed by a document management service;

FIG. 12 is a diagram for explaining an example of the process relating to access to documents by the document management service;

FIG. 13 is a diagram for explaining an example of the process relating to authentication and ticket decryption by the client service;

FIG. 14 is a diagram for explaining an example of the process relating to additional authentication and ticket decryption by the client service;

FIG. 15 is a diagram for explaining an example of the process relating to access to documents by the client service;

FIG. 16 is a diagram for explaining an example of the internal structure of an authentication ticket;

FIG. 17 is a diagram for explaining an example of a user structure;

FIG. 18 is a diagram for explaining an example of a group information structure;

FIG. 19 is a diagram for explaining an example of the internal structure of an additional authentication ticket;

FIG. 20 is a diagram for explaining an example of the internal structure of a session;

FIG. 21 is a diagram for explaining an example of an access-right managing table;

FIG. 22 is a flowchart showing an example of the process relating to authentication performed by the authentication service;

FIG. 23 is a flowchart showing an example of the process relating to additional authentication performed by the authentication service;

FIG. 24 is a flowchart showing an example of the process relating to ticket decryption performed by the authentication service;

FIG. 25 is a flowchart showing an example of the process relating to the commencement of a session by the document management service;

FIG. 26 is a flowchart showing an example of the process relating to access to documents performed by the document management service;

FIG. 27 is a flowchart showing an example of the process relating to authentication and ticket decryption performed by the client service;

FIG. 28 is a flowchart showing an example of the process relating to additional authentication and ticket decryption by the client service;

FIG. 29 is a flowchart showing an example of the process relating to the start of a session performed by the client service;

FIG. 30 is a flowchart showing an example of the process relating to access to documents by the client service;

FIG. 31 is an illustrative drawing for explaining an example of the screen relating to authentication results displayed on the user terminal apparatus;

FIG. 32 is a functional block diagrams showing an example of the document management service;

FIG. 33 is a diagram for explaining an example of a secrecy-level management table;

FIG. 34 is a diagram for explaining an example of a document attribute table; and

FIG. 35 is a flowchart showing an example of the process relating to access to documents by the document management service.

### DESCRIPTION OF THE PREFERRED EMBODIMENTS

In the following, embodiments of the present invention will be described with reference to the accompanying drawings.

### Embodiment 1

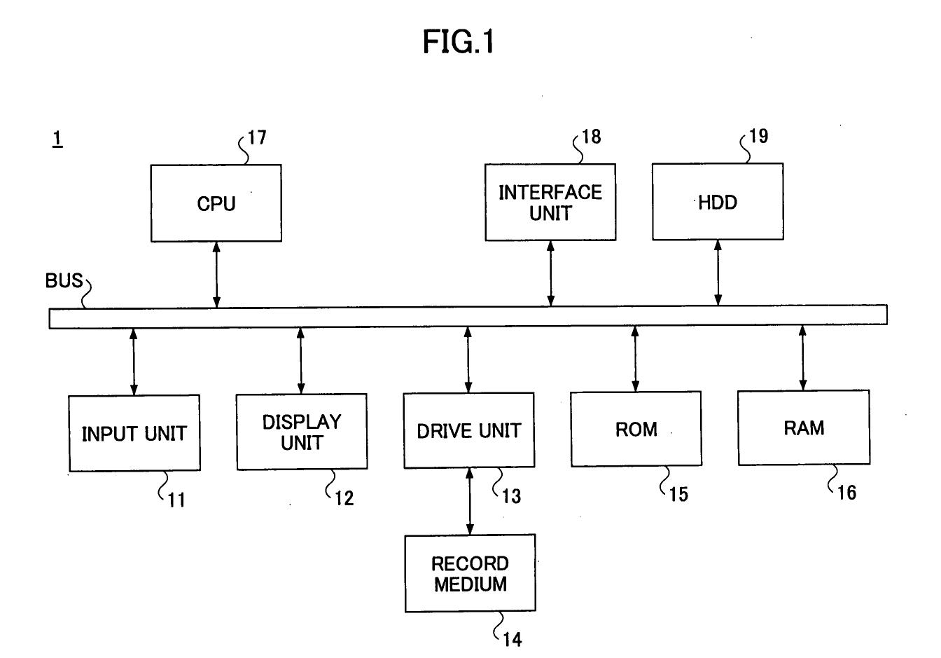

FIG. 1 is a block diagram showing an example of the hardware construction of an authentication service providing server.

The hardware construction of an authentication service providing server 1 shown in FIG. 1 includes an input unit 11, a display unit 12, a drive unit 13, a record medium 14, a ROM (read only memory) 15, a RAM (random access memory) 16, a CPU (central processing unit) 17, an interface unit 18, and an HDD (hard-disk drive) 19, which are coupled to one another through a bus.

The input unit 11 is comprised of a keyboard and mouse, etc., which are operated by the user of the authentication service providing server 1. The input unit 11 is used to input various operating signals into the authentication service providing server 1.

The display unit 12 is comprised of a display, etc., which are used by the user of the authentication service providing server 1. The display unit 12 displays various types of information.

The interface unit 18 serves to connect the authentication service providing server 1 to a network or the like.

Programs such as application programs corresponding to an authentication service 30 and main programs for controlling the overall operation of the authentication service providing server 1 are provided to the authentication service providing server 1 from the record medium 14 such as a CD-ROM, or are downloaded via the network. The record medium 14 is set in the drive unit 13, and the above-noted application programs, main programs, etc., are installed to the ROM 15 from the record medium 14 through the drive unit 13.

The ROM 15 stores data, the application programs, the main programs, etc. These application programs, main programs, etc., are read from the ROM 15 at the time of power-on of the authentication service providing server 1, and are stored in the RAM 16. The CPU 17 carries out processing according to the application programs, main programs, etc., that have been retrieved and stored in the RAM 16.

The HDD 19 stores data, files, etc. For example, the HDD 19 stores an authentication ticket 60, an additional authentication ticket 70, user information, group information, etc., which will be described later.

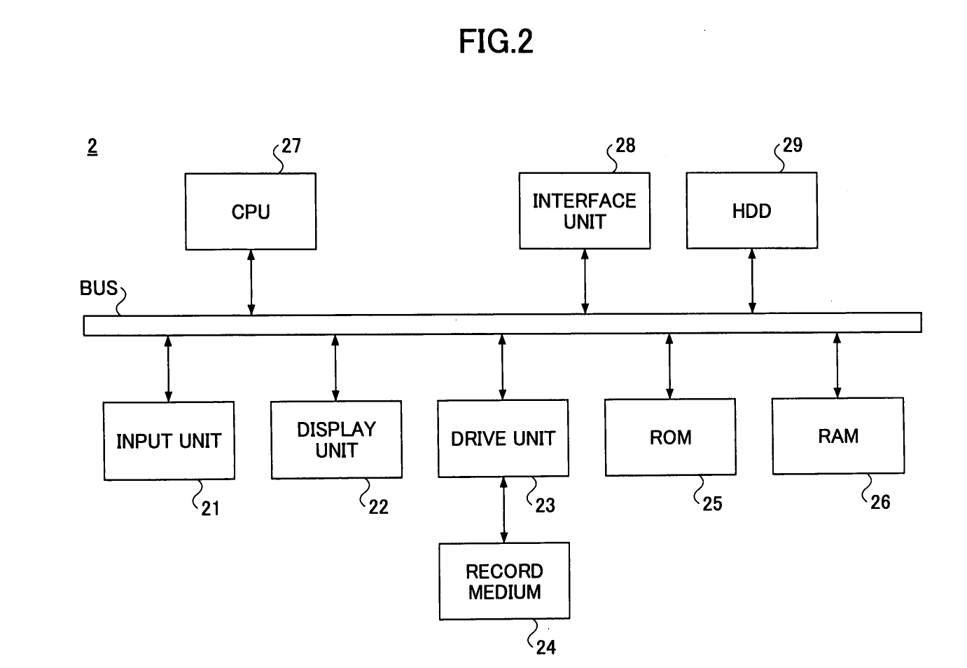

In the following, an example of the hardware construction of a Web service providing server 2 will be described with reference to FIG. 2.

FIG. 2 is a block diagram showing an example of the hardware construction of the Web service providing server.

The hardware construction of the Web service providing server 2 shown in FIG. 2 includes an input unit 21, a display unit 22, a drive unit 23, a record medium 24, a ROM 25, a RAM 26, a CPU 27, an interface unit 28, and an HDD 29, which are coupled to one another via a bus.

The input unit 21 is comprised of a keyboard and mouse, etc., which are operated by the user of the Web service providing server 2. The input unit 21 is used to input various operating signals into the Web service providing server 2.

The display unit 22 is comprised of a display, etc., which are used by the user of the Web service providing server 2. The display unit 22 displays various types of information.

The interface unit 28 serves to connect the Web service providing server 2 to the network or the like.

Programs such as application programs corresponding to a document management service 40 and main programs for controlling the overall operation of the Web service providing server 2 are provided to the Web service providing server 2 from the record medium 24 such as a CD-ROM, or are downloaded via the network. The record medium 24 is set in the drive unit 23, and the above-noted application programs, main programs, etc., are installed to the ROM 25 from the record medium 24 through the drive unit 23.

The ROM 25 stores data, the application programs, the main programs, etc. These application programs, main programs, etc., are read from the ROM 25 at the time of power-on of the Web service providing server 2, and are stored in the RAM 26. The CPU 27 carries out processing according to the application programs, main programs, etc., that have been retrieved and stored in the RAM 26.

The HDD 29 stores data, files, etc. For example, the HDD 29 stores the URLs (uniform resource locators) of a session 80 and the authentication service 30 for providing a service relating to authentication, and also stores an access-right managing table 90.

In the embodiment of the present invention as described above, the authentication service 30, which will be described later, is implemented in the authentication service providing server 1, and the document management service 40, which will be described later, is implemented in the Web service providing server 2. It should be noted that the authentication service 30 and the document management service 40 may as well be implemented on the same server.

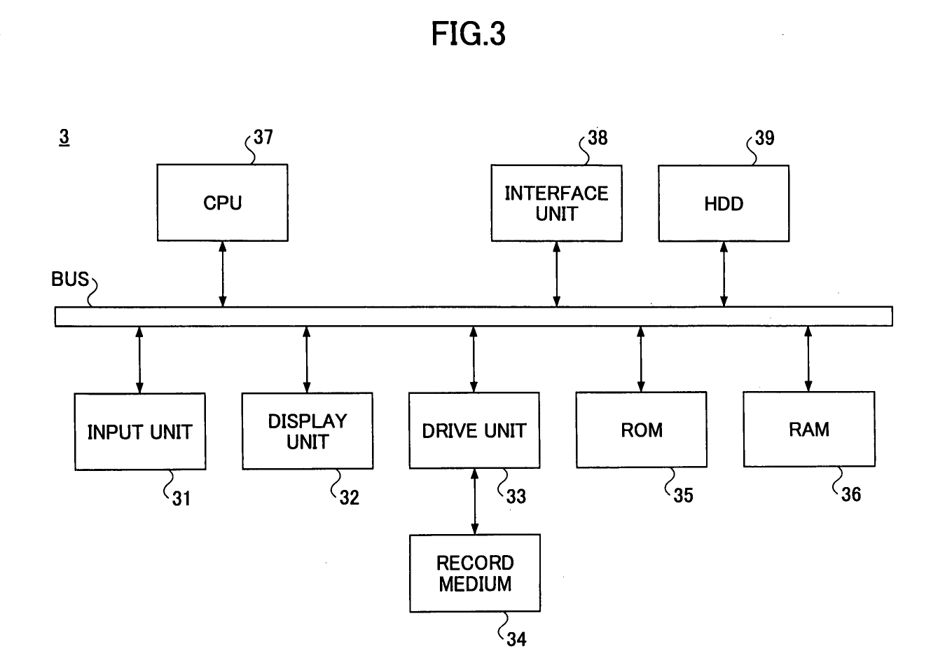

In the following, an example of the hardware construction of a user terminal apparatus 3 will be described with reference to FIG. 3.

FIG. 3 is a block diagram showing an example of the hardware construction of the user terminal apparatus.

The hardware construction of the user terminal apparatus 3 shown in FIG. 3 includes an input unit 31, a display unit 32, a drive unit 33, a record medium 34, a ROM 35, a RAM 36, a CPU 37, an interface unit 38, and an HDD 39, which are coupled to one another via a bus.

The input unit 31 is comprised of a keyboard and mouse, etc., which are operated by the user of the user terminal apparatus 3. The input unit 31 is used to input various operating signals into the user terminal apparatus 3.

The display unit 32 is comprised of a display, etc., which are used by the user of the user terminal apparatus 3. The display unit 32 displays various types of information.

The interface unit 38 serves to connect the user terminal apparatus 3 to the network or the like.

Programs such as application programs corresponding to a client service 50 and main programs for controlling the overall operation of the user terminal apparatus 3 are provided to the user terminal apparatus 3 from the record medium 34 such as a CD-ROM, or are downloaded via the network. The record medium 34 is set in the drive unit 33, and the above-noted application programs, main programs, etc., are installed to the ROM 35 from the record medium 34 through the drive unit 33.

The ROM 35 stores data, the application programs, the main programs, etc. These application programs, main programs, etc., are read from the ROM 35 at the time of power-on of the user terminal apparatus 3, and are stored in the RAM 36. The CPU 37 carries out processing according to the application programs, main programs, etc., that have been retrieved and stored in the RAM 36.

The HDD 39 stores data, files, etc. For example, the HDD 39 stores an authentication ticket ID, an additional authentication ticket ID, an authentication level, etc, which will be described later.

The authentication service 30, the document management service 40, and the client service 50 provide Web services, and exchange messages with each other based on the SOAP (simple object access protocol), for example.

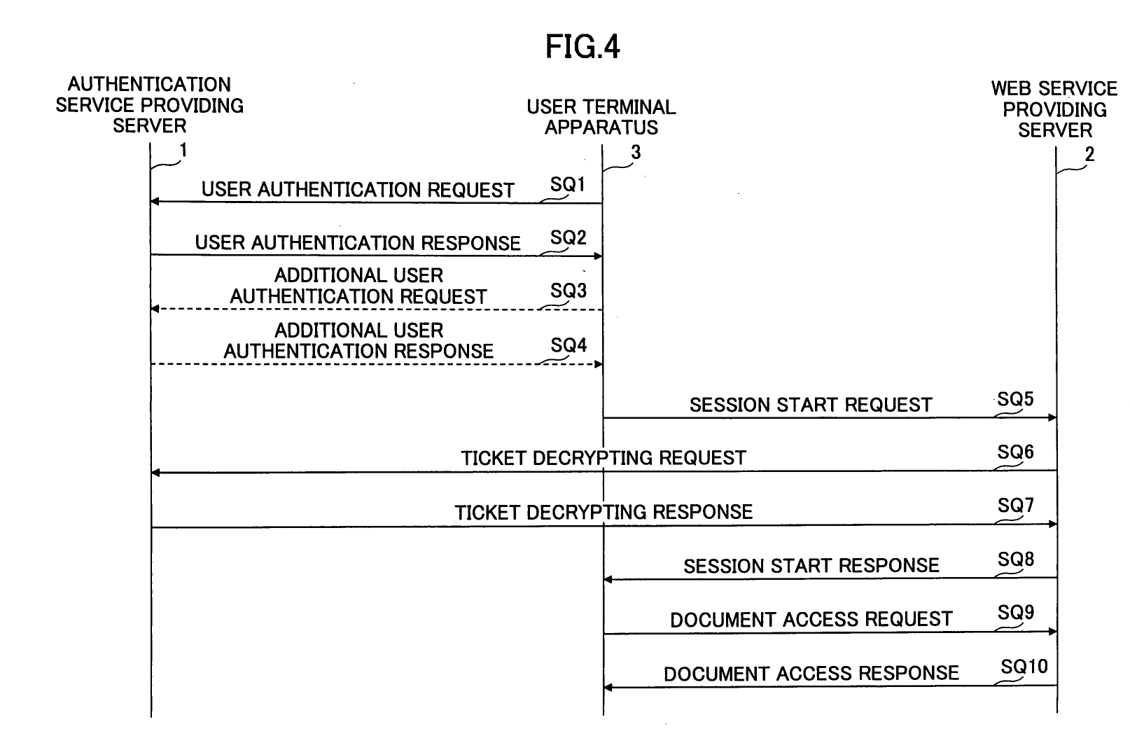

In the following, an example of an authentication service providing method, an Web service providing method, and an Web service utilizing method will be described with reference to FIG. 4.

FIG. 4 is a sequence chart for explaining the example of the authentication service providing method, the Web service providing method, and the Web service utilizing method.

As shown in FIG. 4, the user terminal apparatus 3 using the Web service provided by the Web service providing server 2 generates a user authentication request for authenticating the user of the user terminal apparatus 3, and transmits the request to the authentication service providing server 1 (sequence SQ1).

The authentication service providing server 1 performs an authentication based on the user name, password, etc., included in the user authentication request, and calculates an authentication level as will be described later, thereby creating an authentication ticket 60 inclusive of the authentication level. The authentication service providing server 1 creates a user authentication response inclusive of an authentication ticket ID that identifies the created authentication ticket 60, and transmits the user authentication response to the user terminal apparatus 3 (sequence SQ2).

The user authentication request transmitted from the user terminal apparatus 3 at sequence SQ1 may include not only the data for a single authentication such as (User Name, Password) but also the data for multiple authentications such as (User Name, Password, Fingerprint Data of Index Finger), for example. When the user authentication request includes data for multiple authentications, the authentication service providing server 1 performs such authentications by use of respective authentication means (authentication engines), and calculates an authentication level, thereby creating the authentication ticket 60 inclusive of the authentication level.

Moreover, there may be a need to raise the authentication level. To this end, the user terminal apparatus 3 creates an additional user authentication request relating to the additional authentication of the user. The additional user authentication requests includes an authentication ticket ID and data for additional authentication such as fingerprint data or the like if the user authentication request transmitted in sequence SQ1 includes the user name and password. The additional user authentication request is then transmitted to the authentication service providing server 1 (sequence SQ3).

The authentication service providing server 1 performs an authentication based on the authentication ticket ID and fingerprint data included in the additional user authentication request, and calculates an authentication level, thereby creating the additional authentication ticket 70 inclusive of the authentication level. The authentication service providing server 1 further creates an additional authentication response inclusive of an additional authentication ticket ID for identifying the created additional authentication ticket 70, and transmits the additional authentication response to the user terminal apparatus 3 (sequence SQ4).

In FIG. 4, the user terminal apparatus 3 transmits the additional user authentication request to the authentication service providing server 1 only once. This is not intended to limit the scope of the embodiment of the invention. In order to raise an authentication level, for example, the additional user authentication request inclusive of data for additional authentication may be transmitted twice, three times, or as many times as necessary to the authentication service providing server 1. In response, the authentication service providing server 1 may perform an authentication at every turn to calculate an authentication level. The same also applies in the following description.

On the other hand, if there is no necessity of raising an authentication level, the processes of sequence SQ3 and sequence SQ4 may not need to be performed.

TIn the following, the user terminal apparatus 3 creates a session start request inclusive of the authentication ticket ID or additional authentication ticket ID acquired in sequence SQ2 or sequence SQ4 for transmission to the Web service providing server 2 (sequence SQ5).

The Web service providing server 2 creates a ticket decrypting request inclusive of the authentication ticket ID or additional authentication ticket ID contained in the session start request for transmission to the authentication service providing server 1 (sequence SQ6).

The authentication service providing server 1 acquires the authentication level, user information, etc. contained in the authentication ticket 60 or additional authentication ticket 70 based on the authentication ticket ID or additional authentication ticket ID contained in the ticket decrypting request. The authentication service providing server 1 thus creates a ticket decrypting response inclusive of the authentication level, user information, etc., for transmission to the Web service providing server 2 (sequence SQ7).

The Web service providing server 2 receives the ticket decrypting response from the authentication service providing server 1. Upon confirming that the authentication ticket ID or additional authentication ticket ID contained in the session start request received in sequence SQ5 is valid, the Web service providing server 2 creates the session 80. The Web service providing server 2 then creates a session start response inclusive of the session ID for identifying the created session 80 for transmission to the user terminal apparatus 3 (sequence SQ8).

The user terminal apparatus 3 creates a document access request including the session ID, the document ID for identifying a document to be accessed, and access type (e.g., Read, Write, or the like). The document access request is then transmitted to the Web service providing server 2 (sequence SQ9).

The Web service providing server 2 searches in the access-right managing table 90 based on the document ID contained in the document access request as well as the authentication level and user information that are acquired in sequence SQ7 and associated with the session ID. As will be described later, the access-right managing table 90 manages information about access rights with respect to documents. If there is information relating to the corresponding access right, the Web service providing server 2 acquires the information relating to the access right. The Web service providing server 2 then compares the acquired information relating to the access right with the access type contained in the document access request. If access can be made in accordance with the requested access right, the Web service providing server 2 accesses the document corresponding to the document ID (e.g., Read, Wright, or the like), and creates a document access response inclusive of access results for transmission to the user terminal apparatus 3.

The authentication service providing method, the Web service providing method, and the Web service utilizing method as described above make it possible to efficiently manage information about access rights with respect to documents without a need to manage the information about access rights in association with a plurality of authentication means (authentication engines). This provides for document-related services.

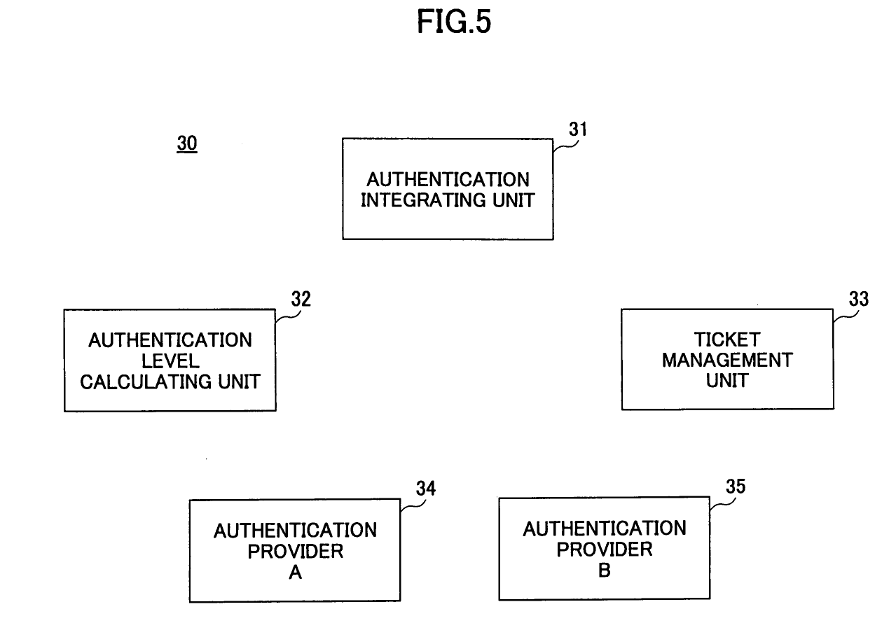

In the following, an example of the functional configuration of the authentication service 30 will be described with reference to FIG. 5. FIG. 5 is a block diagram showing an example of the functional configuration of the authentication service.

As shown in FIG. 5, the authentication service 30 includes an authentication integrating unit 31, an authentication level calculating unit 32, a ticket management unit 33, an authentication provider A 34, and an authentication provider B 35.

The authentication integrating unit 31 serves as a module for controlling the overall operation of the authentication service 30. Further, the authentication integrating unit 31 serves to provide common interface for the client service 50 and the document management service 40.

The authentication level calculating unit 32 serves as a module for calculating an authentication level based on the authentication engine used for authentication and the authentication level of this authentication engine. The detail of how to calculate the authentication level will be described later.

The ticket management unit 33 serves as a module for managing the authentication ticket 60 and/or the additional authentication ticket 70, which will be described later.

The authentication provider A 34 and the authentication provider B 35 are an “authentication provider” module. Here, the authentication provider plays the role of an adapter or intermediary for incorporating various authentication engines into the authentication service 30. The authentication engines are systems for actually performing authentication processes such as password matching, fingerprint matching, etc.

Namely, each authentication engine has its own interface (protocol). In order to provide the authentication function of the authentication engines as Web services to the client service 50, there is a need to conform to the predetermined interface that is defined in relation to the authentication integrating unit 31. It is the authentication provider that provides a common interface for the authentication integrating unit 31 by absorbing the protocol variations of individual authentication engines. It follows that the introduction of an additional authentication engine to the authentication service 30 requires an additional authentication provider. It should be noted, however, that the authentication provider itself may possess the function of an authentication engine. In the following, it is assumed that authentication engines are incorporated in the authentication providers unless it is contrarily stated.

In FIG. 5, the configuration of the authentication service 30 is described with reference to a case in which the two authentication providers, i.e., the authentication provider A 34 and the authentication provider B 35, are included in the authentication service 30. This is not intended to limit the scope of the embodiment of the invention. The number of authentication providers may be one, or may be two or more.

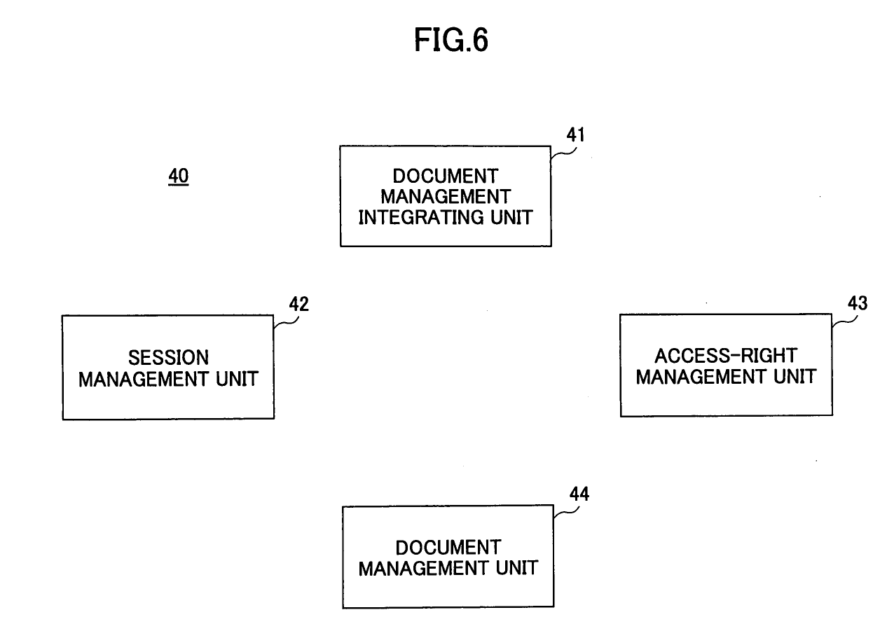

In the following, an example of the functional configuration of the document management service 40 will be described with reference to FIG. 6. FIG. 6 is a functional block diagram showing an example of the document management service.

As shown in FIG. 6, the document management service 40 includes a document management integrating unit 41, a session management unit 42, an access-right management unit 43, and a document management unit 44.

The document management integrating unit 41 serves as a module for controlling the overall operation of the document management service 40. The document management integrating unit 41 also serves to provide a common interface for the client service 50 and the authentication service 30.

The session management unit 42 serves as a module for managing the session 80, which will be described later.

The access-right management unit 43 serves as a module for managing the access-right managing table 90, which will be described later.

The document management unit 44 serves as a module for managing documents.

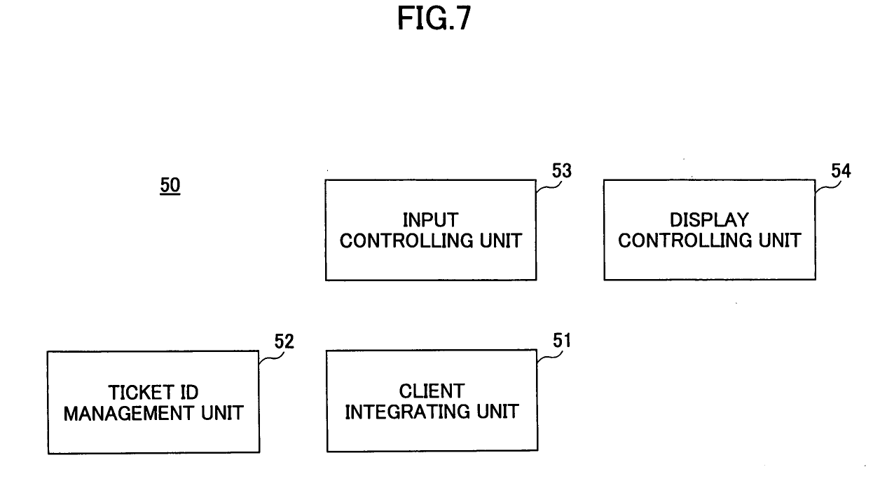

In the following, an example of the functional configuration of the client service 50 will be described with reference to FIG. 7. FIG. 7 is a functional block diagram showing an example of the client service.

As shown in FIG. 7, the client 50 includes a client integrating unit 51, a ticket ID management unit 52, an input controlling unit 53, and a display controlling unit 54.

The client integrating unit 51 serves as a module for controlling the overall operation of the client service 50. The client integrating unit 51 also serves to provide a common interface for the authentication service 30 and the document management service 40.

The ticket ID management unit 52 serves as a module for managing the authentication ticket ID and/or the additional authentication ticket ID.

The input controlling unit 53 serves as a module for controlling input information entered by the user of the user terminal apparatus 3. For example, the input controlling unit 53 acquires input information entered by the user using the screen currently displayed on the display unit 32.

The display controlling unit 54 serves as a module for controlling display on the display unit 32. For example, the display controlling unit 54 may create a screen including the authentication result of user authentication and/or the authentication result of additional user authentication, and displays the screen on the display unit 32. Further, the display controlling unit 54 may create a screen inclusive of the authentication level specified in the authentication ticket 60 and/or the authentication level specified in the additional authentication ticket 70, and displays the screen on the display unit 32.

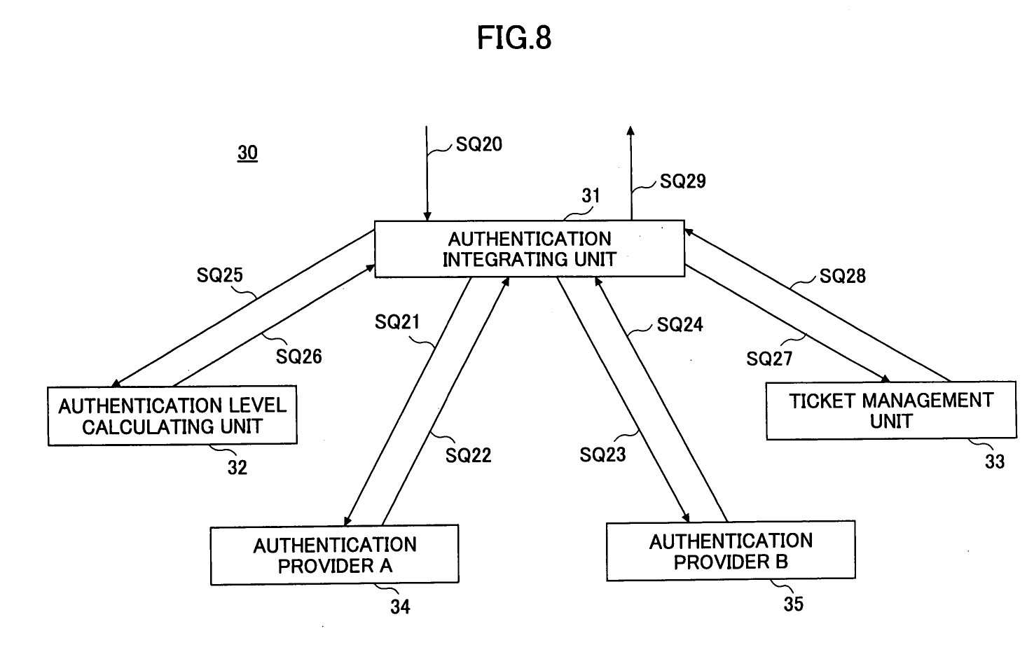

In the following, an example of the authentication process by the authentication service 30 will be described with reference to FIG. 8. FIG. 8 is a diagram for explaining an example of the authentication process performed by the authentication service.

The authentication integrating unit 31 receives the user authentication request transmitted from the client service 50 (sequence SQ20). Here, the user authentication request in FIG. 8 includes a user name, a password, the fingerprint data of an index finger, and the name of the authentication provider that performs an authentication.

The authentication integrating unit 31 transmits the data (e.g., the user name and password) concerning the corresponding authentication to the authentication provider A 34 based on the name of the authentication provider performing an authentication as specified in the user authentication request (sequence SQ21).

The authentication integrating unit 31 receives, from the authentication provider A 34, the identifier indicative of the authentication provider A 34 and the authentication result inclusive of the authentication level (e.g., 1) indicating the strength of authentication of the authentication provider A 34 (sequence SQ22).

Moreover, the authentication integrating unit 31 transmits the data (e.g., the user name and the fingerprint data of an index finger) concerning the corresponding authentication to the authentication provider B 35 based on the name of the authentication provider that performs an authentication as specified in the user authentication request (sequence SQ23).

The authentication integrating unit 31 receives, from the authentication provider B 35, the identifier indicative of the authentication provider B 35 and the authentication result inclusive of the authentication level (e.g., 2) indicating the strength of authentication of the authentication provider B 35 (sequence SQ24).

The authentication integrating unit 31 passes a request for the calculation of an authentication level to the authentication level calculating unit 32 (sequence SQ25). This calculating request includes the identifier indicative of the authentication provider A 34 and the authentication level (e.g., 1) of the authentication provider A 34 received in sequence SQ22 and the identifier indicative of the authentication provider B 35 and the authentication level of the authentication provider B 35 received in sequence SQ24.

The authentication level calculating unit 32 calculates an authentication level based on the identifiers indicative of the authentication providers and the authentication levels of the authentication providers supplied from the authentication integrating unit 31, and passes the calculated authentication level (e.g., 3) as a calculation result to the authentication integrating unit 31 (sequence SQ26).

In the following, examples of a method of calculating an authentication level by the authentication level calculating unit 32 will be described. A calculation method 1 selects the strongest authentication level among the authentication levels received as parameters. For the sake of explanation, it is agreed that the authentication level of the Windows (registered trademark) NT authentication provider and the authentication level of the Notes (registered trademark) authentication provider are 1, the authentication level of the fingerprint authentication provider being 2 for an index finger only and 3 for all the ten fingers, the authentication level of the magnetic-card authentication provider being 1, and the authentication level of the IC-card authentication provider being 2. When the identifier indicative of the Windows (registered trademark) NT authentication provider, the authentication level “1” of the Windows (registered trademark) NT authentication provider, the identifier indicative of the fingerprint authentication provider, and the authentication level “2” of the fingerprint authentication provider for an index finger only are received as parameters, the authentication level calculating unit 32 selects the strongest authentication level “2” as the calculation result.

A calculation method 2 obtains as the calculation result an authentication level that is the sum of the authentication levels received as parameters. When the identifier indicative of the Windows (registered trademark) NT authentication provider, the authentication level “1” of the Windows (registered trademark) NT authentication provider, the identifier indicative of the fingerprint authentication provider, and the authentication level “2” of the fingerprint authentication provider for an index finger only are received as parameters, the authentication level calculating unit 32 obtains as the calculation result an authentication level “3” that is the sum of the two authentication levels received as the parameters.

A calculation method 3 classifies the authentication providers into predetermined categories (e.g., password-based authentication, biometrical authentication, device-based authentication, etc.) based on the identifiers of the authentication providers received as parameters, and obtains as the calculation result the sum of values each of which is the maximum of authentication levels within each category. When the identifier indicative of the Windows (registered trademark) NT authentication provider, the authentication level “1” of the Windows (registered trademark) NT authentication provider, the identifier indicative of the Notes (registered trademark) authentication provider, the authentication level “1” of the Notes (registered trademark) authentication provider, the identifier indicative of the fingerprint authentication provider, the authentication level “2” of the fingerprint authentication provider for an index finger only, the identifier indicative of the magnetic-card authentication provider, the authentication level “1” of the magnetic-card authentication provider, the identifier indicative of the IC-card authentication provider, and the authentication level “2” of the IC-card authentication provider are received as parameters, the authentication level calculating unit 32 classifies the Windows (registered trademark) NT authentication and the Notes (registered trademark) authentication as the password-based authentication, the fingerprint authentication as the biometrical authentication, and the magnetic-card authentication and the IC-card authentication as the device-based authentication. Further, the authentication level calculating unit 32 obtains as the calculation result an authentication level “5” that is the sum of the maximum values of the authentication levels in the respective categories (MAX(1, 1)+2+MAX(1, 2)=1+2+2=5).

The authentication service 30 (or the authentication level calculating unit 32) may be configured to perform a predetermined one of the calculation methods described above. Alternatively, the authentication service 30 (or the authentication level calculating unit 32) may be configured to check a flag indicative of calculation methods defined in the definition file or the like stored in the HDD 19 of the authentication service providing server 1, thereby changing the calculation methods according to the flag.

In FIG. 8, the authentication integrating unit 31 issues a request for creating the authentication ticket 60 to the ticket management unit 33 (sequence SQ27). The request includes the authentication level received from the authentication level calculating unit 32 in sequence SQ26.

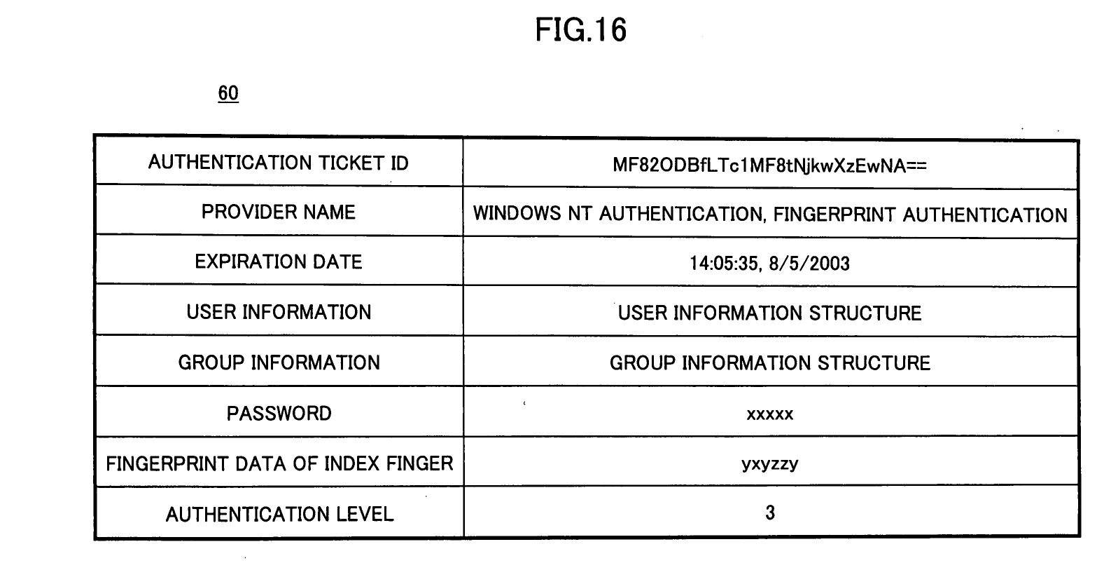

The ticket management unit 33 creates the authentication ticket 60 inclusive of the authentication level received from the authentication integrating unit 31, and manages this authentication ticket 60. The ticket management unit 33 supplies an authentication ticket ID indicative of the authentication ticket 60 to the authentication integrating unit 31 as the authentication ticket 60 (sequence SQ28). The detail of the authentication ticket 60 will be described later with reference to FIG. 16.

The authentication integrating unit 31 creates the user authentication response inclusive of the authentication ticket ID received from the ticket management unit 33, and transmits the user authentication response to the client service 50 (sequence SQ29).

Through the processing as shown in FIG. 8, the authentication service 30 creates the authentication ticket 60 inclusive of the authentication level according to the user authentication request supplied from the client service 50. The authentication service 30 then transmits the user authentication response inclusive of the authentication ticket ID for identifying the authentication ticket 60 to the client service 50.

The description given in connection with FIG. 8 has been directed to a case in which the user authentication request includes the name of the authentication provider that performs an authentication. If the authentication provider name is not included in the user authentication request, the authentication integrating unit 31 may transmit the user authentication request to all the authentication providers included in the authentication service 30. The same applies in the following description.

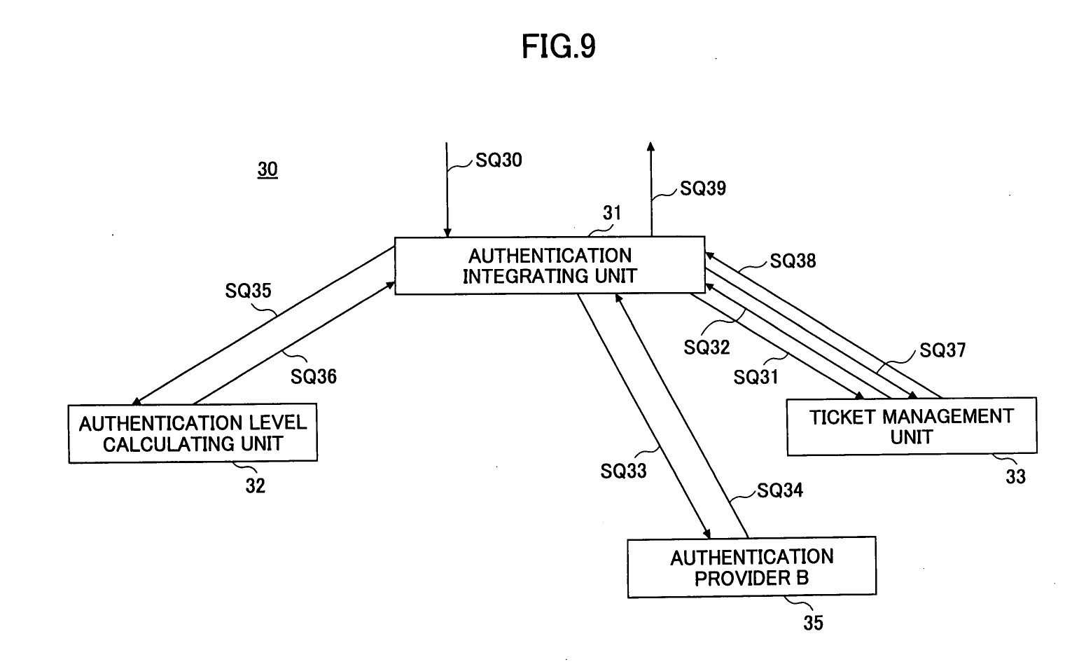

In the following, an example of the process relating to additional authentication performed by the authentication service 30 will be described with reference to FIG. 9. FIG. 9 is a diagram for explaining an example of the process relating to the additional authentication performed by the authentication service.

The authentication integrating unit 31 receives the additional user authentication request transmitted from the client service 50 (sequence SQ30). The additional user authentication request of FIG. 9 includes the authentication provider that performs an additional authentication, an authentication ticket ID, the fingerprint data of ten fingers, for example.

The authentication integrating unit 31 supplies the authentication ticket ID contained in the additional user authentication request to the ticket management unit 33, thereby requesting the decryption of the authentication ticket 60 (sequence SQ31).

According to the authentication ticket ID supplied from the authentication integrating unit 31, the ticket management unit 33 acquires the authentication level, user information, group information, etc., contained in the corresponding authentication ticket 60, and supplies them to the authentication integrating unit 31 as the results of decryption of the authentication ticket 60 (sequence SQ32).

The authentication integrating unit 31 transmits the data (e.g., the results of decryption of the authentication ticket 60 and the fingerprint data of ten fingers) concerning the corresponding additional authentication to the authentication provider B 35 based on the name of the authentication provider that performs the additional authentication as specified in the additional user authentication request (sequence SQ33).

The authentication integrating unit 31 receives, from the authentication provider B 35, the identifier indicative of the authentication provider B 35 and the authentication result inclusive of the authentication level indicating the strength of authentication of the authentication provider B 35 (sequence SQ34). In the case of fingerprint authentication by use of ten fingers, for example, the authentication result inclusive of the authentication level “3” is received from the authentication provider B 35 (sequence SQ34).

The authentication integrating unit 31 supplies a request for authentication level calculation to the authentication level calculating unit 32 (sequence SQ35). This request includes the identifier indicative of the authentication provider B 35 and the authentication level of the authentication provider B 35 received in sequence SQ34, and also includes the result of decryption of the authentication ticket 60.

Based on the identifier indicative of the authentication provider, the authentication level of the authentication provider, and the result of decryption of the authentication ticket 60 (or the name and authentication level of the authentication provider contained in the result of decryption of the authentication ticket 60) received from the authentication integrating unit 31, the authentication level calculating unit 32 calculates the authentication level, and supplies the calculated authentication level as a result of calculation to the authentication integrating unit 31 (sequence SQ36).

The calculation method 3 as described above may be used by the authentication level calculating unit 32 to calculate an authentication level. For example, the authentication provider B 35 may be a fingerprint authentication provider, and the authentication level “3” for ten-finger authentication is included as a parameter. Further, the result of decryption of the authentication ticket 60 supplied as a parameter may include, as the authentication providers, the fingerprint authentication provider and the Windows (registered trademark) NT authentication provider, and may also include “3” as the authentication level. In this case, the authentication level calculating unit 32 ascertains that the authentication level “3” is the sum of the authentication level “1” of the Windows (registered trademark) NT authentication provider and the authentication level “2” of the fingerprint authentication provider for an index finger. The authentication level calculating unit 32 classifies the authentication providers into categories, and obtains as a result of calculation the authentication level “4” that is the sum of maximum values of authentication levels in those categories (MAX(1)+MAX(2, 3)=1+3=4).

The authentication integrating unit 31 supplies the request for creating the additional authentication ticket 70 inclusive of the received authentication level to the ticket management unit 33 (sequence SQ37).

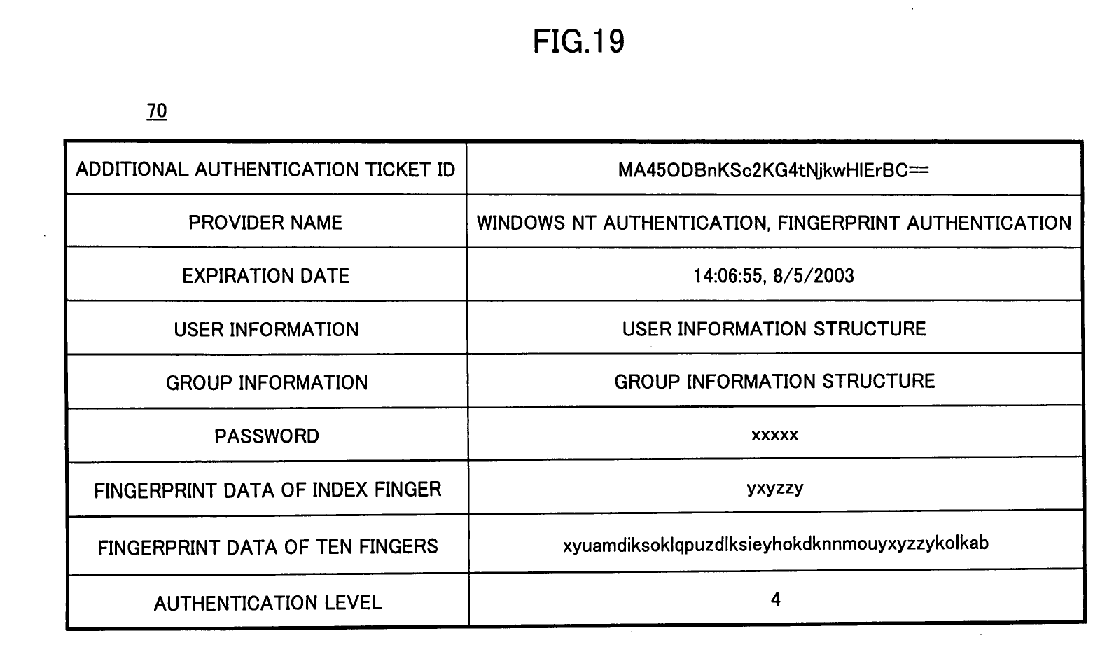

The ticket management unit 33 creates the additional authentication ticket 70 inclusive of the authentication level received from the authentication integrating unit 31, and manages the additional authentication ticket 70. Further, the ticket management unit 33 supplies an additional authentication ticket ID for identifying the additional authentication ticket 70 to the authentication integrating unit 31 as the additional authentication ticket 70 (sequence SQ38). The detail of the additional authentication ticket 70 will be described later with reference to FIG. 19.

The authentication integrating unit 31 creates an additional user authentication response inclusive of the additional authentication ticket ID received from the ticket management unit 33, and transmits the response to the client service 50 (sequence SQ39).

Through the processes as shown in FIG. 9, the authentication service 30 creates the additional authentication ticket 70 inclusive of the authentication level in response to the additional user authentication request supplied from the client service 50. The authentication service 30 then transmits the additional user authentication response inclusive of the authentication ticket ID for identifying the additional authentication ticket 70 to the client service 50.

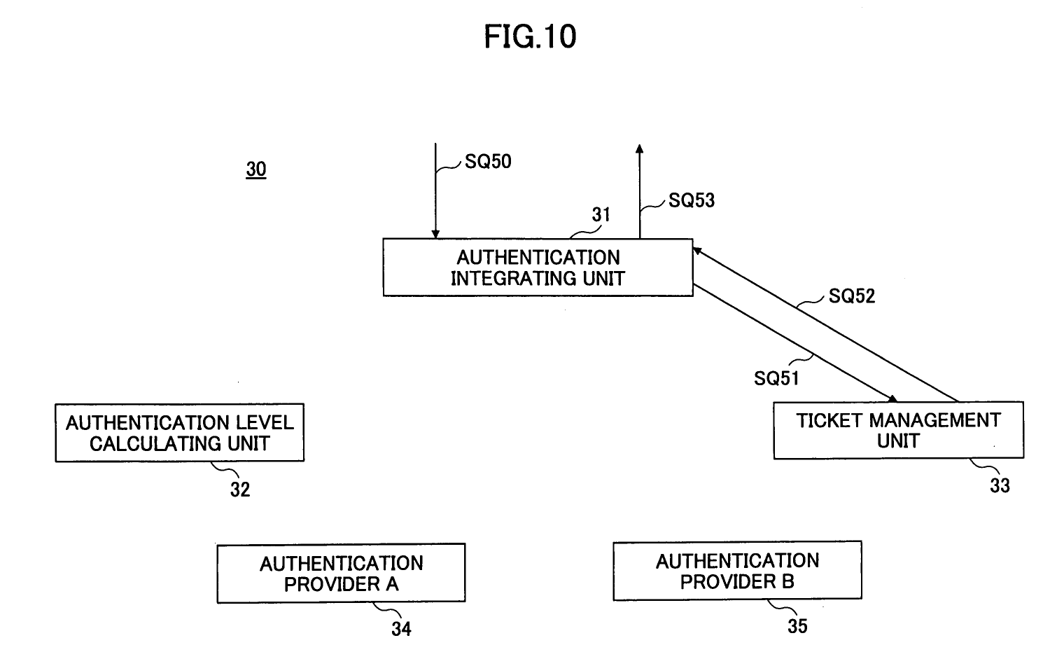

In the following, an example of the process relating to ticket decryption by the authentication service 30 will be described with reference to FIG. 10. FIG. 10 is a diagram for explaining an example of the process relating to ticket decryption by the authentication service.

The authentication integrating unit 31 receives a ticket decrypting request inclusive of the authentication ticket ID or additional authentication ticket ID transmitted from the client service 50 or the document management service 40 (sequence SQ50).

The authentication integrating unit 31 supplies to the ticket management unit 33 the authentication ticket ID or additional authentication ticket ID contained in the ticket decrypting request, and requests the decryption of the authentication ticket 60 or additional authentication ticket 70 (sequence SQ51).

In response to the authentication ticket ID or additional authentication ticket ID supplied from the authentication integrating unit 31, the ticket management unit 33 acquires the authentication level, user information, group information, etc., contained in the corresponding authentication ticket 60 or additional authentication ticket 70. The ticket management unit 33 then supplies the acquired information to the authentication integrating unit 31 as the result of decryption of the authentication ticket 60 or additional authentication ticket 70 (sequence SQ52).

The authentication integrating unit 31 creates a ticket decrypting response including the authentication level, user information, group information, etc., contained in the authentication ticket 60 or additional authentication ticket 70 received from the ticket management unit 33, and transmits them to the client service 50 or the document management service 40 (sequence SQ53).

Through the processes as shown in FIG. 10, the authentication service 30 decrypts the authentication ticket 60 or additional authentication ticket 70 in response to the ticket decrypting request supplied from the client service 50 or the document management service 40. The authentication service 30 then transmits the ticket decrypting response including the authentication level, user information, group information, etc., contained in the authentication ticket 60 or additional authentication ticket 70 to the client service 50 or the document management service 40.

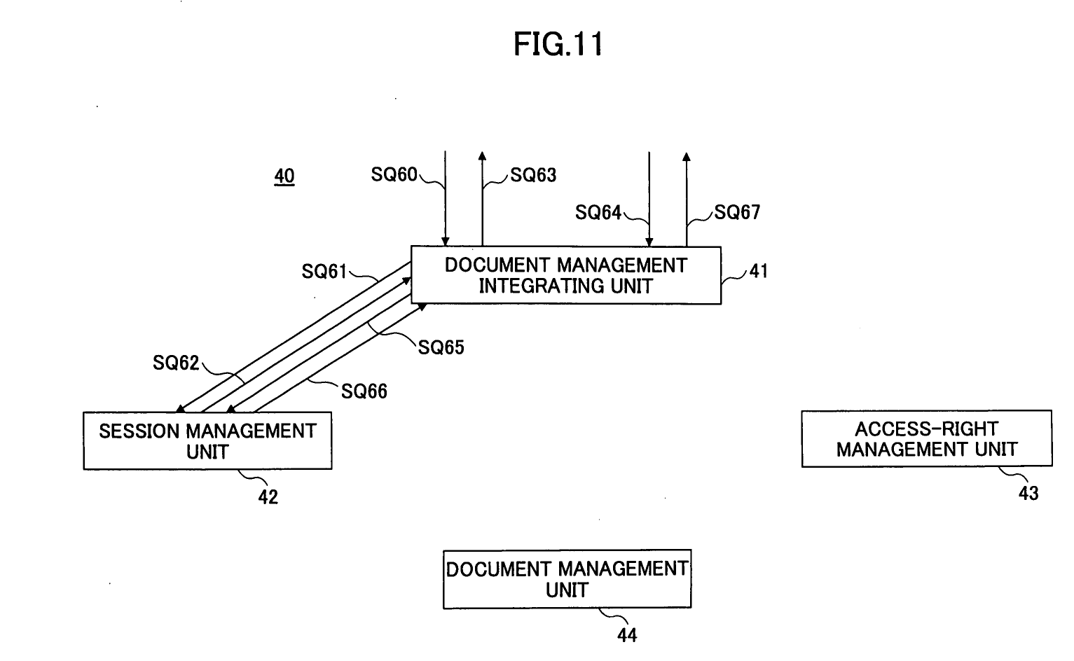

In the following, an example of the process relating to the commencement of a session by the document management service 40 will be described with reference to FIG. 11. FIG. 11 is a diagram for explaining an example of the process relating to the commencement of a session by the document management service.

The document management integrating unit 41 receives a session start request inclusive of the authentication ticket ID or additional authentication ticket ID transmitted from the client service 50 (sequence SQ60).

The document management integrating unit 41 passes the session management unit 42 the authentication ticket ID or additional authentication ticket ID contained in the session start request, and requests the start of a session (sequence SQ61).

Upon receiving the request for the start of a session inclusive of the authentication ticket ID or additional authentication ticket ID from the document management integrating unit 41, the session management unit 42 creates a ticket decrypting request inclusive of the received authentication ticket ID or additional authentication ticket ID. The session management unit 42 then transmits the ticket decrypting request to the authentication service 30 through the document management integrating unit 41 (sequence SQ62, sequence SQ63).

Moreover, the session management unit 42 receives a ticket decrypting response including the authentication level, user information, group information, etc., contained in the authentication ticket 60 or additional authentication ticket 70 transmitted from the authentication service 30 through the document management integrating unit 41 (sequence SQ64, sequence SQ65).

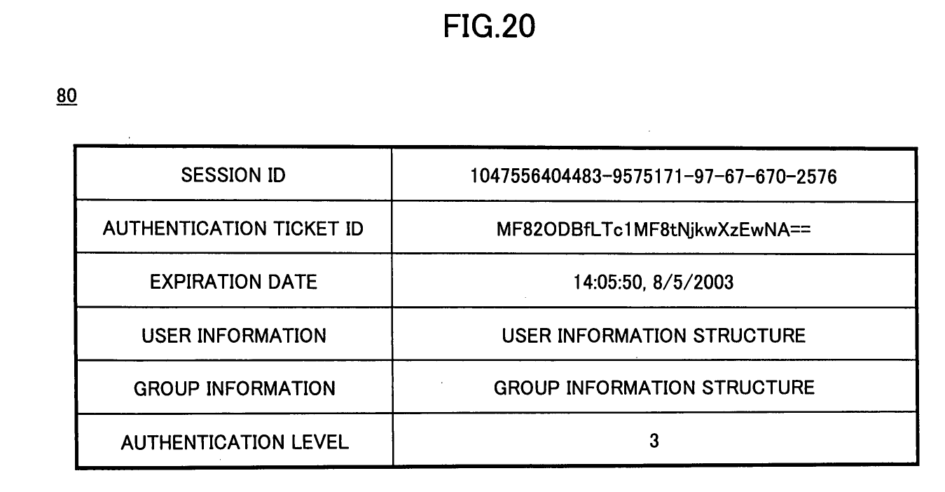

The session management unit 42 creates the session 80 including the authentication level, user information, group information, etc., contained in the ticket decrypting response, and manages the session 80. Further, the session management unit 42 supplies to the document management integrating unit 41 the session ID indicative of the session 80 as the session 80 (sequence SQ66). The detail of the session 80 will be described later with reference to FIG. 20. In this embodiment, the session 80 is so configured as to include an authentication level, user information, group information, etc. Alternatively, an authentication level, user information, group information, etc., may not be included in the session 80, but may be managed by the session management unit 42 in such a manner as to be associated with the session 80.

The document management integrating unit 41 creates the session start response inclusive of the session ID received from the session management unit 42, and transmits the response to the client service 50 (sequence SQ67).

Through the processes: as shown in FIG. 11, the document management service 40 creates the session 80 in response to the session start request from the client service 50, and transmits the session start response inclusive of the session ID to the client service 50.

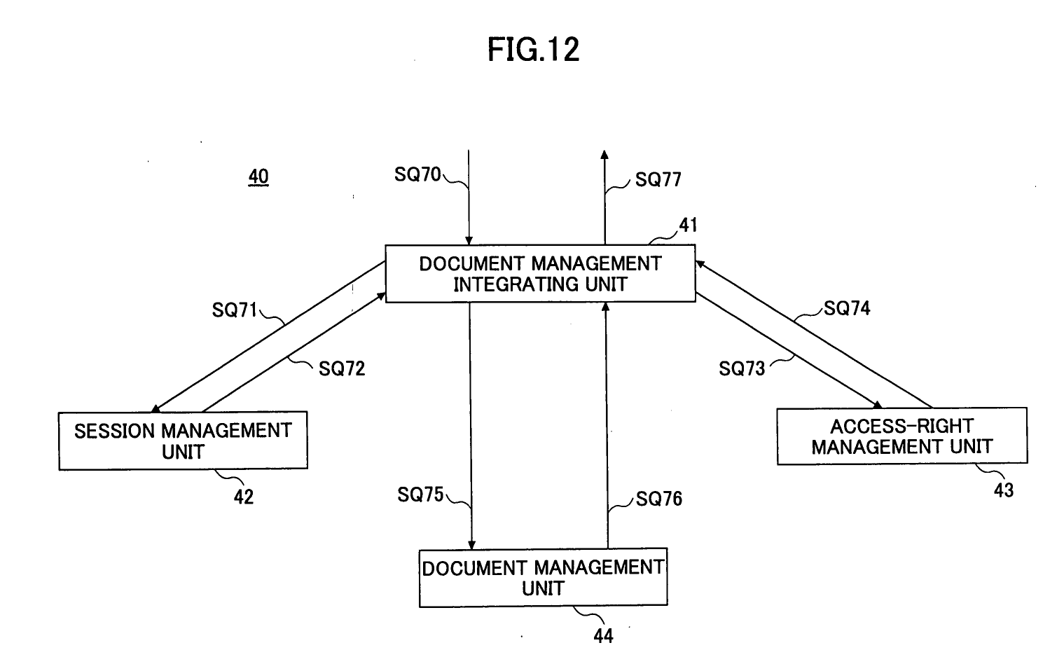

In the following, an example of the process relating to access to documents by the document management service 40 will be described with reference to FIG. 12. FIG. 12 is a diagram for explaining an example of the process relating to access to documents by the document management service.

The document management integrating unit 41 receives a document access request including a session ID, a document ID and access type (e.g., Read, Write, etc.) transmitted from the client service 50 (sequence SQ70).

The document management integrating unit 41 passes the session management unit 42 the session ID contained in the document access request, and requests the acquisition of corresponding authentication level and user information (sequence SQ71).

The session management unit 42 acquires, from the session 80 or the like, the authentication level and user information corresponding to the session ID received from the document management integrating unit 41, and supplies the acquired information to the document management integrating unit 41 (sequence SQ72).

The document management integrating unit 41 passes the access-right management unit 43 the authentication level received from the session management unit 42, the user ID contained in the user information received from the session management unit 42, and the document ID contained in the document access request, thereby requesting a check as to the information about access rights (sequence SQ73.).

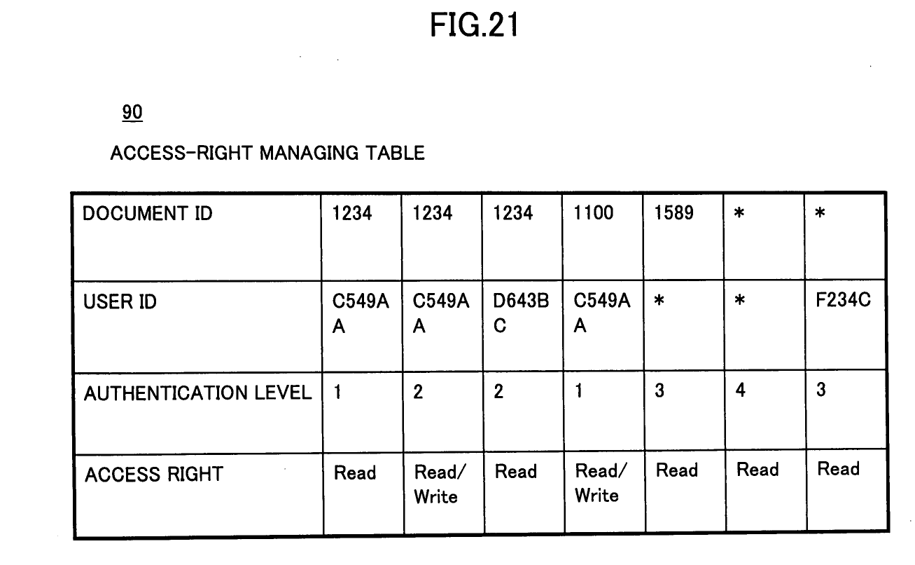

The access-right management unit 43 searches in the access-right managing table 90 based on the authentication level, the user ID, and the document ID received from the document management integrating unit 41. If there is information relating to the corresponding access right, the access-right management unit 43 supplies the information relating to the access right to the document management integrating unit 41 as a check result (sequence SQ74). Alternatively, the information relating to the access right may not be supplied to the document management integrating unit 41 as a check result. In place of such information itself, for example, a check result indicative of “OK” or “NG” may be supplied to the document management integrating unit 41. The same applies in the following description. The detail of the access-right managing table 90 will be described later with reference to FIG. 21.

As will be described later, information about access rights is managed in association with the authentication level according to the present invention, which makes it possible to manage the information about access rights more efficiently than in a case in which information about access rights is managed in association with authentication means (authentication engines). If authentication means (authentication engines) and access-right information are associated with each other for the management purpose, the presence of multiple authentication means (authentication engines) necessitates that the setting and managing of access-right information be performed separately for each combination of the authentication means (authentication engines). This results in cumbersomely complicated management, which may fail if the number of authentication means (authentication engines) increases. The use of authentication levels, on the other hand, provides for the setting and managing of access-right information to be performed according to authentication levels. In this case, the complexity of management does not increase even if the number of authentication means (authentication engines) increases.

Moreover, modification to the authentication means (authentication engines) does not have a direct impact on the access-right managing table 90. If the level of a modified authentication means remains the same before and after the modification, there is no need to change the access-right managing table 90.

In FIG. 12, the document management integrating unit 41 passes the document management unit 44 an access request inclusive of the type of access to the document if the check result received from the access-right management unit 43 includes information about valid access right (for example, the type of access included in the document access request is “Read” whereas the check result received from the access-right management unit 43 is “Read” or “Read/Write”) (sequence SQ75).

Based on the type of access included in the access request received from the document management integrating unit 41, the document management unit 44 attends to processing and supplies the access result to the document management integrating unit 41 (sequence SQ76).

The document management integrating unit 41 creates a document access response including the access result received from the document management unit 44, and transmits the response to the client service 50 (sequence SQ77).

Through the processes as shown in FIG. 12, the document management service 40 checks information about access rights in response to the document access request from the client service 50. If there is information relating to valid access right, the document management service 40 accesses the corresponding document, and transmits the document access response including access results to the client service 50.

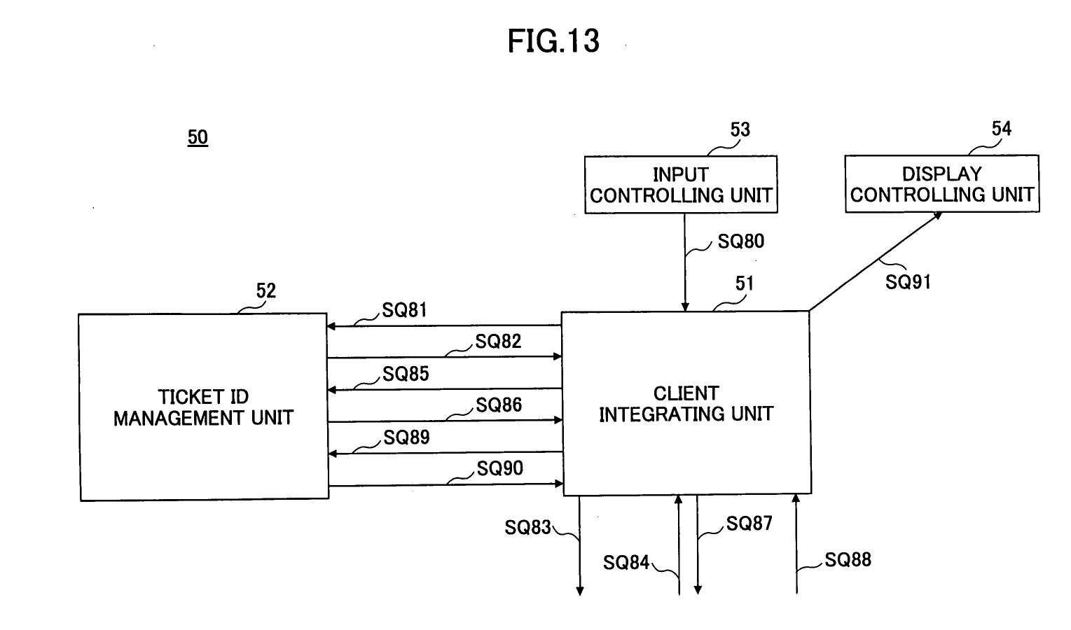

In the following, an example of the process relating to authentication and ticket decryption by the client service 50 will be described with reference to FIG. 13. FIG. 13 is a diagram for explaining an example of the process relating to authentication and ticket decryption by the client service.

The input controlling unit 53 passes the client integrating unit 51 information indicative of an authentication request including the authentication-related data (e.g., a user name, a password, the fingerprint data of an index finger) entered by the user (sequence SQ80).

The client integrating unit 51 passes the ticket ID management unit 52 the information indicative of an authentication request including the authentication-related data received from the input controlling unit 53 (sequence SQ81).

The ticket ID management unit 52 creates a user authentication request inclusive of the authentication-related data received from the client integrating unit 51, and transmits the request to the authentication service 30 through the client integrating unit 51 (sequence SQ82, sequence SQ83).

Moreover, the ticket ID management unit 52 receives a user authentication response inclusive of the authentication result and/or the authentication ticket ID supplied from the authentication service 30 through the client integrating unit 51 (sequence SQ84, sequence SQ85.). The ticket ID management unit 52 manages the authentication ticket ID contained in the user authentication response.

Moreover, the ticket ID management unit 52 creates a ticket decrypting request inclusive of the authentication ticket ID, and transmits this request to the authentication service 30 through the client integrating unit 51 (sequence SQ86, sequence SQ87).

The ticket ID management unit 52 receives through the client integrating unit 51 a ticket decrypting response including the authentication level, user information, group information, etc., contained in the authentication ticket 60 corresponding to the authentication ticket ID transmitted from the authentication service 30 (sequence SQ88, sequence SQ89).

The ticket ID management unit 52 supplies the authentication result contained in the user authentication response and/or the authentication level and the like contained in the ticket decrypting response to the client integrating unit 51, and requests the displaying of a screen that shows the authentication result and/or the authentication level and the like (sequence SQ90).

The client integrating unit 51 passes the display controlling unit 54 the authentication result and/or the authentication level and the like supplied from the ticket ID management unit 52, and requests the displaying of a screen that shows the authentication result and/or the authentication level and the like (sequence SQ91).

The display controlling unit 54 creates a screen that shows the authentication result and/or the authentication level and the like received from the client integrating unit 51, and displays the screen on the display device or the like.

Through the processes as shown in FIG. 13, the client service 50 transmits the user authentication request to the authentication service 30, and receives the user authentication response inclusive of the authentication ticket ID. Moreover, the client service 50 creates the ticket decrypting request using the authentication ticket ID contained in the user authentication response for transmission to the authentication service 30, and receives the ticket decrypting response inclusive of an authentication level and the like, thereby displaying a screen that shows the authentication results and/or the authentication level and the like.

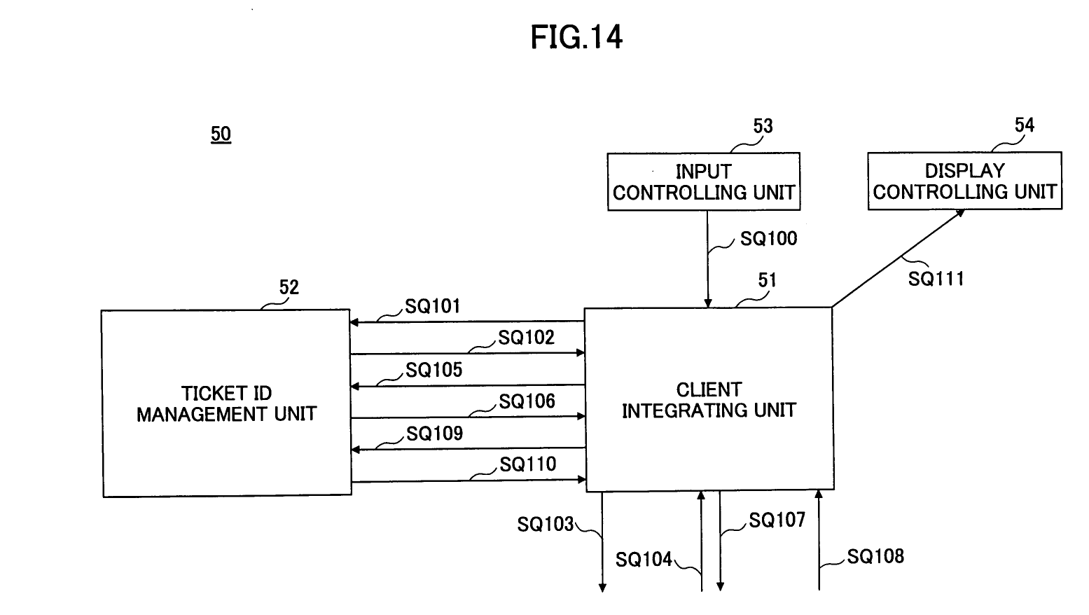

In the following, an example of the process relating to additional authentication and ticket decryption by the client service 50 will be described with reference to FIG. 14. FIG. 14 is a diagram for explaining an example of the process relating to additional authentication and ticket decryption by the client service.

The input controlling unit 53 passes the client integrating unit 51 information indicative of an additional authentication request including the additional-authentication-related data (e.g., the fingerprint data of the ten fingers) entered by the user (sequence SQ100).

The client integrating unit 51 passes the ticket ID management unit 52 the information indicative of an additional authentication request including the additional-authentication-related data received from the input controlling unit 53 (sequence SQ101).

The ticket ID management unit 52 creates an additional user authentication request inclusive of the additional-authentication-related data received from the client integrating unit 51 and the corresponding authentication ticket ID, and transmits this request to the authentication service 30 through the client integrating unit 51 (sequence SQ102, sequence SQ103).

Moreover, the ticket ID management unit 52 receives an additional user authentication response inclusive of the additional authentication result and/or the additional authentication ticket ID supplied from the authentication service 30 through the client integrating unit 51 (sequence SQ104, sequence SQ105). The ticket ID management unit 52 manages the additional authentication ticket ID contained in the additional user authentication response.

Moreover, the ticket ID management unit 52 creates a ticket decrypting request inclusive of the additional authentication ticket ID, and transmits this request to the authentication service 30 through the client integrating unit 51 (sequence SQ106, sequence SQ107).

The ticket ID management unit 52 receives through the client integrating unit 51 a ticket decrypting response including the authentication level, user information, group information, etc., contained in the additional authentication ticket 70 corresponding to the additional authentication ticket ID transmitted from the authentication service 30 (sequence SQ108, sequence SQ109).

The ticket ID management unit 52 supplies the additional authentication result contained in the additional user authentication response and/or the authentication level and the like contained in the ticket decrypting response to the client integrating unit 51, and requests the displaying of a screen that shows the additional authentication result and/or the authentication level and the like (sequence SQ110).

The client integrating unit 51 passes the display controlling unit 54 the authentication result and/or the authentication level and the like supplied from the ticket ID management unit 52, and requests the displaying of a screen that shows the additional authentication result and/or the authentication level and the like (sequence SQ111).

The display controlling unit 54 creates a screen that shows the additional authentication result and/or the authentication level and the like received from the client integrating unit 51, and displays the screen on the display device or the like.

Through the processes as shown in FIG. 14, the client service 50 transmits the additional user authentication request to the authentication service 30, and receives the additional user authentication response inclusive of the additional authentication ticket ID. Moreover, the client service 50 creates the ticket decrypting request using the additional authentication ticket ID contained in the additional user authentication response for transmission to the authentication service 30, and receives the ticket decrypting response inclusive of an authentication level and the like, thereby displaying a screen that shows the additional authentication results and/or the authentication level and the like.

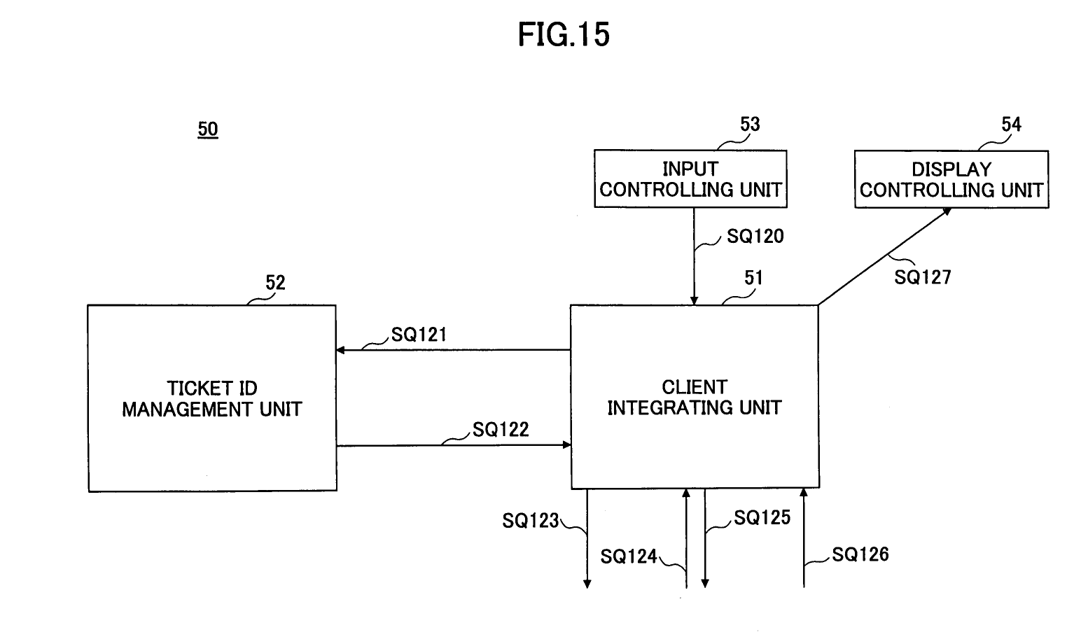

In the following, an example of the process relating to access to documents by the client service 50 will be described with reference to FIG. 15. FIG. 15 is a diagram for explaining an example of the process relating to access to documents by the client service.

The input controlling unit 53 passes the client integrating unit 51 information indicative of a document access request including a document ID indicative of a document and an access type (e.g., Read, Write, etc.) entered or selected by the user (sequence SQ120).

The client integrating unit 51 keeps the document ID and the access type received from the input controlling unit 53, and passes the ticket ID management unit 52 the information indicative of a document access request (sequence SQ121).

The ticket ID management unit 52 creates a session start request inclusive of the corresponding authentication ticket ID or additional authentication ticket ID, and transmits this request to the document management service 40 through the client integrating unit 51 (sequence SQ122, sequence SQ123).

The client integrating unit 51 receives a session start response inclusive of a session ID transmitted from the document management service 40 (sequence SQ124). The client integrating unit 51 manages the session ID contained in the session start response. Although no illustration is given, a session-ID management unit may be provided in the client service 50 for the purpose of managing the session ID.

The client integrating unit 51 creates a document access request including the session ID as well as the document ID and access type stored in memory, and transmits this request to the document management service 40 (sequence SQ125).

Moreover, the client integrating unit 51 receives a document access response including access results transmitted from the document management service 40 (sequence SQ126).

The client integrating unit 51 passes the access results to the display controlling unit 54, and requests the displaying of a screen that shows the access results and the like (sequence SQ127).

The display controlling unit 54 creates a screen that shows the access results and the like received from the client integrating unit 51, and displays the screen on the display device or the like.

Through the processes as shown in FIG. 15, the client service 50 transmits the session start request to the document management service 40, and receives the session start response inclusive of the session ID. Moreover, the client service 50 creates a document access request by use of the session ID contained in the session start response for transmission to the document management service 40, and receives the document access response including access results and the like, thereby displaying a screen that shows the access results and the like.

In the following, an example of the internal structure of the authentication ticket 60 managed by the ticket management unit 33 of the authentication service 30 will be described with reference to FIG. 16. FIG. 16 is a diagram for explaining an example of the internal structure of an authentication ticket.

As shown in FIG. 16, the authentication ticket 60 includes an authentication ticket ID, a provider name, an expiration date, user information, group information, a password, the fingerprint data of an index finger, and an authentication level, for example.

The authentication ticket ID stores an identifier indicative of the authentication ticket 60. The provider name stores the name of an authentication provider that has performed an authentication. In an example of FIG. 16, the names of two authentication providers having performed an authentication are listed.

The expiration date stores an expiration date of the authentication ticket 60. The user information stores a structure of user information indicative the authenticated user. The group information stores an array of pointers pointing to structures of group information indicative of groups to which the user belongs.

The password stores a password that is used for authentication (Windows (registered trademark) NT authentication). The fingerprint data of an index finger stores the fingerprint data of an index finger used for authentication (fingerprint authentication).

The authentication level stores an authentication level calculated by the authentication level calculating unit 32 as previously described.

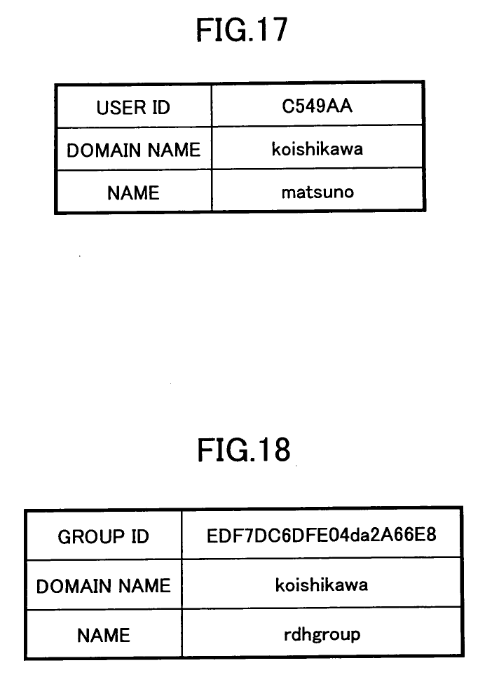

In the following, an example of the user information structure will be described with reference to FIG. 17. FIG. 17 is a diagram for explaining an example of the user structure.

As shown in FIG. 17, the user information structure includes a user ID, a domain name, and a name.

The user ID stores an identifier indicative of a user. The domain name stores a domain name corresponding to the user. The name stores the name of the user.

In the following, an example of the group information structure will be described with reference to FIG. 18. FIG. 18 is a diagram for explaining an example of the group information structure.

As shown in FIG. 18, the group information structure includes a group ID, a domain name, and a name.

The group ID stores an identifier indicative of a group to which the above-noted user belongs. The domain name stores a domain name corresponding to the group. The name stores the name of the group.

In the following, an example of the internal structure of the additional authentication ticket 70 managed by the ticket management unit 33 of the authentication service 30 will be described with reference to FIG. 19. FIG. 19 is a diagram for explaining an example of the internal structure of an additional authentication ticket.

As shown in FIG. 19, the additional authentication ticket 70 includes an additional authentication ticket ID, a provider name, an expiration date, user information, group information, a password, the fingerprint data of an index finger, the fingerprint data of the ten fingers, and an authentication level, for example.

The additional authentication ticket ID stores an identifier indicative of the additional authentication ticket 70. The provider name stores the name of an authentication provider that has performed an authentication. In an example of FIG. 19, the names of two authentication providers having performed an authentication are listed.

The expiration date stores an expiration date of the additional authentication ticket 70. The user information stores a structure of user information indicative the authenticated user. The group information stores an array of pointers pointing to structures of group information indicative of groups to which the user belongs.

The password stores a password that is used for authentication (Windows (registered trademark) NT authentication). The fingerprint data of an index finger stores the fingerprint data of an index finger used for authentication (fingerprint authentication). The fingerprint data of the ten fingers stores the fingerprint data of the ten fingers used for authentication (fingerprint authentication).

The authentication level stores an authentication level calculated by the authentication level calculating unit 32 as previously described. It should be noted that the authentication level shown in FIG. 19 is increased by one in comparison with the authentication level shown in FIG. 16.

In the following, an example of the internal structure of the session 80 managed by the session management unit 42 of the document management service 40 will be described with reference to FIG. 20. FIG. 20 is a diagram for explaining an example of the internal structure of a session. In what follows, an example of the session 80 created based on the authentication ticket 60 will be shown.

As shown in FIG. 20, the session 80 includes a session ID, an authentication ticket ID, an expiration date, user information, group information, and an authentication level, for example.

The session ID stores an identifier indicative of the session 80. The authentication ticket ID stores an identifier indicative of the authentication ticket 60 contained in the authentication ticket 60. The expiration date stores an expiration date of the session 80.

The user information stores a user information structure contained in the authentication ticket 60 indicative of the authenticated user, as was described with reference to FIG. 17. The group information stores an array of pointers pointing to group information structures indicative of groups to which the user belongs, as contained in the authentication ticket 60 and as was described with reference to FIG. 18.

The authentication level stores an authentication level contained in the authentication ticket 60.

In the following, an example of the internal structure of the access-right managing table 90 managed by the access-right management unit 43 of the document management service 40 will be described with reference to FIG. 21. FIG. 21 is a diagram for explaining an example of the access-right managing table.

As shown in FIG. 21, Document ID, the access-right managing table 90 includes a plurality of items such as a document ID, a user ID, an authentication level, and the right to access.

The document ID stores an identifier indicative of a document. The user ID stores an identifier indicative of a user. The authentication level stores an authentication level that is necessary to perform the process defined by the right to access with respect to the document identified by the document ID. The right to access stores the process that is allowed to be performed with respect to the document identified by the document ID by use of the authentication level stored in the authentication level.

In the access-right managing table 90 shown in FIG. 21, for example, an authentication level “1” allows the user identified by a user ID C549AA to have only the Read right when accessing the document identified by a document ID 1234. If the authentication level is changed to “2”, the Read right and the Write right are permitted.

In the access-right managing table 90 shown in FIG. 21, further, any user having the authentication level “3” is allowed to read the document identified by a document ID 1589. In the access-right managing table 90 shown in FIG. 21, moreover, a user having the authentication level “4” is allowed to read all the documents. In the access-right managing table 90 shown in FIG. 21, further, the user identified by a user ID F234C can read all the documents if the user is cleared with the authentication level “3”.

As shown in FIG. 21, information relating to access rights regarding documents is controlled by use of authentication levels rather than by use of authentication providers. This eliminates a need to take into account all the combinations of authentication providers, thereby making it possible to effectively manage the information relating to access rights regarding documents.

Further, even when a change or increase/decrease in the authentication providers is made, the use of authentication levels for management provides for the information relating to access rights regarding documents to be effectively managed.

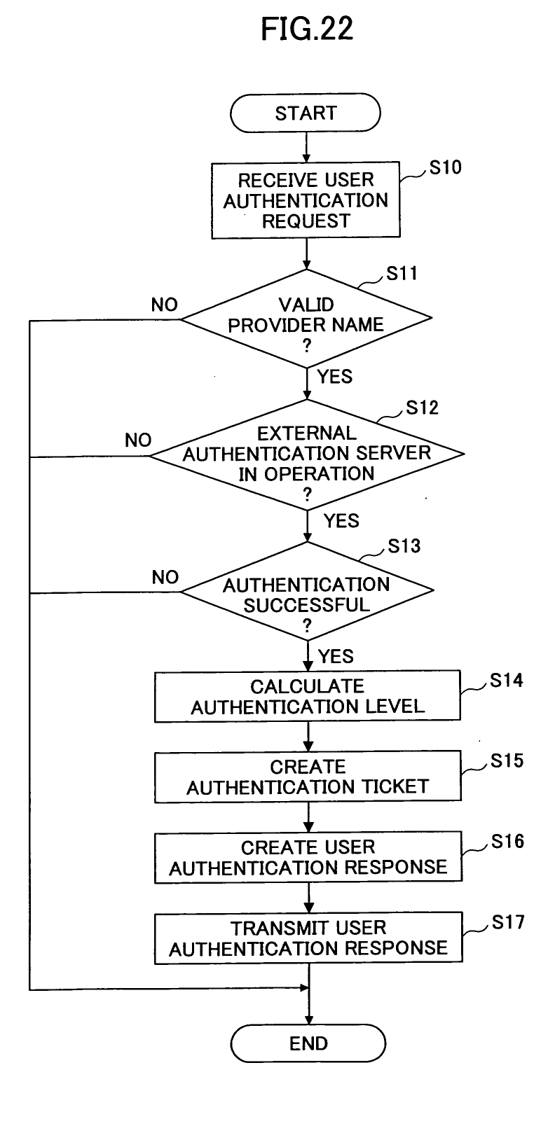

In the following, an example of the process relating to authentication by the authentication service 30 will be described with reference to FIG. 22. FIG. 22 is a flowchart showing an example of the process relating to authentication performed by the authentication service. In what follows, a description will be given by assuming that authentication engines are provided in external authentication servers or the like that are different from the authentication service providing server 1.

At step S10, the authentication service 30 receives the user authentication request inclusive of a user name, a password, the fingerprint data of an index finger, the name of an authentication provider that performs an authentication, for example, when the request is transmitted from the client service 50.

At step S11 following step S10, the authentication service 30 checks whether the authentication provider name included in the user authentication request is a valid authentication provider name. If the check determines that it is a valid authentication provider name (YES at step S11), the authentication service 30 goes to step S12. If the check finds that it is not a valid authentication provider name, the authentication service 30 brings the procedure to an end.

For example, the authentication service 30 compares the authentication provider name included in the user authentication request with authentication provider names kept in a management database, thereby checking whether any one of the valid provider names matches.

At step S12, the authentication service 30 checks whether an external authentication server is operating. If it is found that the corresponding external authentication server is operating (YES at step S12), the authentication service 30 transmits a user authentication request inclusive of authentication-related data such as (User Name, Password) and/or (User Name, Fingerprint Data of Index Finger) to the corresponding external authentication server.

If it is found that the corresponding external authentication server is not operating (NO at step S12), the authentication service 30 brings the procedure to an end.

For example, the authentication service 30 transmits a ping (Packet Internet Groper) to the corresponding external authentication server to check whether the external authentication server is operating.

At step S13, the authentication service 30 checks whether authentication has been successful. If the check finds that authentication has been successful (YES at step S13), the authentication service 30 proceeds to step S14. If the check finds that authentication has failed (NO at step S13), the authentication service 30 brings the procedure to an end.

For example, the authentication service 30 determines that authentication has been successful if an authentication result or the like indicative of the success of authentication is received from the external authentication server. The authentication result may include an identifier indicative of an authentication provider, the authentication level of this authentication provider, etc.

The processes from step S11 to step S13 are repeated as many times as there are authentications.

At step S14, the authentication service 30 calculates an authentication level based on the identifier indicative of an authentication provider and the authentication level of this authentication provider.

Proceeding to step S15 after step S14, the authentication service 30 creates the authentication ticket 60 inclusive of the authentication level calculated in step S14.

Proceeding to step S16 after step S15, the authentication service 30 creates the user authentication response inclusive of an authentication ticket ID indicative of the authentication ticket 60 created in step S15.

Proceeding to step S17 following step S16, the authentication service 30 transmits the user authentication response created in step S15 to the client service 50 that is the source of the request.

Through the processes as shown in FIG. 22, the authentication service 30 creates the authentication ticket 60 inclusive of the authentication level.

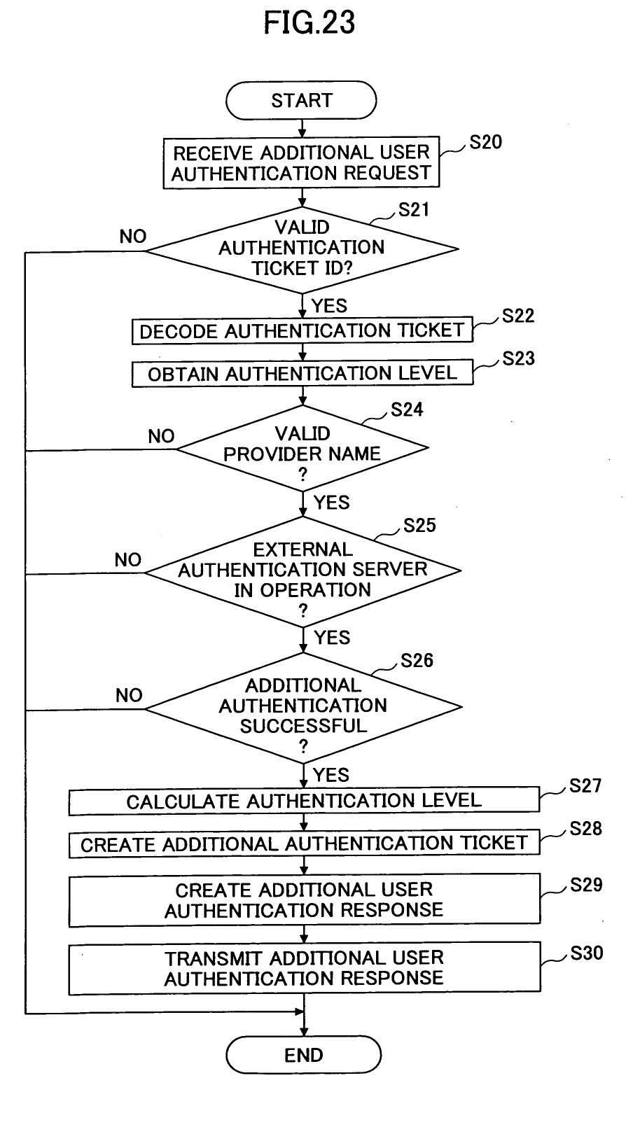

In the following, an example of the process relating to additional authentication performed by the authentication service 30 will be described with reference to FIG. 23. FIG. 23 is a flowchart showing an example of the process relating to additional authentication performed by the authentication service.

At step S20, the authentication service 30 receives an additional user authentication request inclusive of an authentication provider that is to perform an additional authentication, an authentication ticket ID, the fingerprint data of the ten fingers, etc., when such a request is transmitted from the client service 50.

Proceeding to step S21 following step S20, the authentication service 30 checks whether the authentication ticket ID included in the additional user authentication request is a valid authentication ticket ID. If the check finds that it is a valid authentication ticket ID (YES at step S21), the authentication service 30 proceeds to step S22. If the check finds that it is not a valid authentication ticket ID (NO at step S21), the authentication service 30 brings the procedure to an end.

The authentication service 30 checks based on the authentication ticket ID whether a corresponding valid authentication ticket 60 exists, thereby checking whether it is a valid authentication ticket ID.

At step S22, the authentication service 30 decrypts the authentication ticket 60 corresponding to the authentication ticket ID contained in the additional user authentication request.

Proceeding to step S23 following step S22, the authentication service 30 acquires the authentication level, user information, group information, etc., contained in the authentication ticket 60 as decrypted in step S22.

Proceeding to step S24 following step S23, the authentication service 30 checks whether the authentication provider name included in the additional user authentication request is a valid authentication provider name. If the check determines that it is a valid authentication provider name (YES at step S24), the authentication service 30 goes to step S25. If the check finds that it is not a valid authentication provider name (NO at step S24), the authentication service 30 brings the procedure to an end.

For example, the authentication service 30 compares the authentication provider name included in the additional user authentication request with authentication provider names kept in a management database, thereby checking whether any one of the valid provider names matches.

At step S25, the authentication service 30 checks whether an external authentication server is operating. If it is found that the corresponding external authentication server is operating (YES at step S25), the authentication service 30 transmits an additional user authentication request inclusive of (User Name, Fingerprint Data of Ten Fingers) or the like to the corresponding external authentication server. If it is found that the corresponding external authentication server is not operating (NO at step S25), the authentication service 30 brings the procedure to an end.

For example, the authentication service 30 transmits a ping (Packet Internet Groper) to the corresponding external authentication server to check whether the external authentication server is operating.

At step S26, the authentication service 30 checks whether additional authentication has been successful. If the check finds that additional authentication has been successful (YES at step S26), the authentication service 30 proceeds to step S27. If the check finds that authentication has failed (NO at step S26), the authentication service 30 brings the procedure to an end.

For example, the authentication service 30 determines that additional authentication has been successful if an authentication result indicative of the success of additional authentication is received from the external authentication server. The authentication result may include an identifier indicative of an authentication provider, the authentication level of this authentication provider, etc.

The processes from step S24 to step S26 are repeated as many times as there are authentications.

At step S27, the authentication service 30 calculates an authentication level based on the identifier indicative of an authentication provider having performed an additional authentication, the authentication level of this authentication provider, the authentication level contained in the authentication ticket 60 corresponding to the authentication ticket ID contained in the additional user authentication request, etc.

Proceeding to step S28 after step S27, the authentication service 30 creates the additional authentication ticket 70 inclusive of the authentication level newly calculated in step S27.

Proceeding to step S29 after step S28, the authentication service 30 creates the user authentication response inclusive of an additional authentication ticket ID indicative of the additional authentication ticket 70 created in step S28.

Proceeding to step S30 following step S29, the authentication service 30 transmits the user authentication response created in step S29 to the client service 50 that is the source of the request.

Through the processes as shown in FIG. 23, the authentication service 30 creates the additional authentication ticket 70 inclusive of the newly computed authentication level.

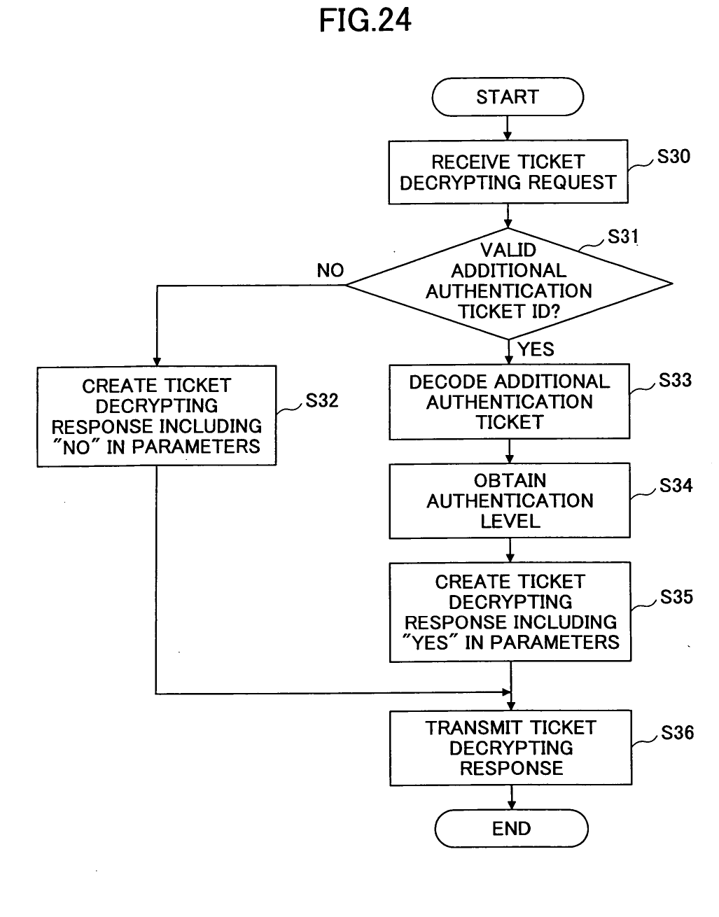

In the following, an example of the process relating to ticket decryption performed by the authentication service 30 will be described with reference to FIG. 24. FIG. 24 is a flowchart showing an example of the process relating to ticket decryption performed by the authentication service.

At step S30, the authentication service 30 receives a request for decrypting the authentication ticket 60 or additional authentication ticket 70 inclusive of the authentication ticket ID or additional authentication ticket ID when such a request is sent from the client service 50 or the document management service 40. In the following, for the sake of simplicity of explanation, a description will be given with reference to a case in which a request for decrypting the additional authentication ticket 70 inclusive of the additional authentication ticket ID is received.

Proceeding to step S31 following step S30, the authentication service 30 checks whether the additional authentication ticket ID included in the request for decrypting the additional authentication ticket 70 is a valid additional authentication ticket ID. If the check finds that it is a valid additional authentication ticket ID (YES at step S31), the authentication service 30 proceeds to step S33. If the check finds that it is not a valid additional authentication ticket ID (NO at step S31), the authentication service 30 proceeds to step S32.

For example, the authentication service 30 checks based on the additional authentication ticket ID included in the request for decrypting the additional authentication ticket 70 whether a valid additional authentication ticket 70 exists, thereby checking whether it is a valid additional authentication ticket ID.

At step S32, the authentication service 30 creates a decryption response regarding the additional authentication ticket 70 including “NO” indicative of a failure of decryption.

At step S33, on the other hand, the authentication service 30 decrypts the additional authentication ticket 70 corresponding to the additional authentication ticket ID contained in the request for decrypting the additional authentication ticket 70.

Proceeding to step S34 following step S33, the authentication service 30 acquires the authentication level, user information, group information, etc., contained in the additional authentication ticket 70 as decrypted in step S33.

Proceeding to step S35 following step S34, the authentication service 30 creates a decryption response regarding the additional authentication ticket 70 inclusive of “YES” indicating a success of decryption, the authentication level, user information, and group information acquired in step S34.

At step S36, the authentication service 30 transmits the decryption response regarding the additional authentication ticket 70 created in step S32 or step S35 to the client service 50 or the document management service 40 that is the source of the request.

Through the processes as shown in FIG. 24, the authentication service 30 decrypts the authentication ticket 60 or additional authentication ticket 70.

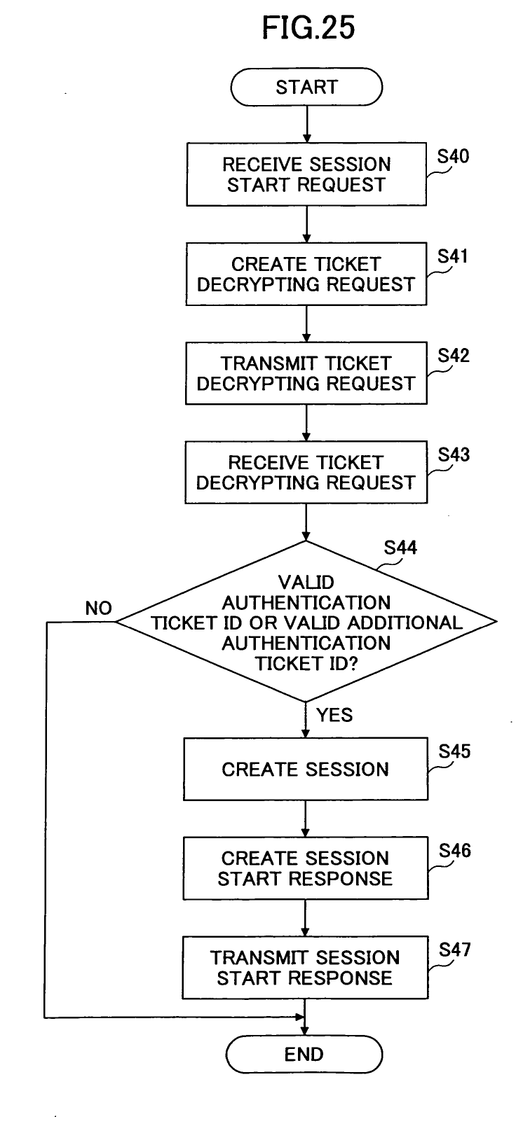

In the following, an example of the process relating to the commencement of a session by the document management service 40 will be described with reference to FIG. 25. FIG. 25 is a flowchart showing an example of the process relating to the commencement of a session by the document management service.

At step S40, the document management service 40 receives a session start request inclusive of the authentication ticket ID or additional authentication ticket ID, for example, transmitted from the client service 50.

Proceeding to step S41 following step S40, the document management service 40 creates a ticket decryption request inclusive of the authentication ticket ID or additional authentication ticket ID.

Proceeding to step S42 following step S41, the document management service 40 transmits the ticket decryption request created in step S40 to a corresponding authentication service 30.

Proceeding to step S43 following step S42, the document management service 40 receives a ticket decrypting response including decryption results from the authentication service 30 that is the recipient of the ticket decryption request.

Proceeding to step S44 following step S43, the document management service 40 checks based on the ticket decryption response received in step S43 whether the authentication ticket ID or additional authentication ticket ID included in the session start request received in step S40 is a valid authentication ticket ID or valid additional authentication ticket ID. If the check finds that it is a valid authentication ticket ID or valid additional authentication ticket ID (YES at step S44), the document management service 40 proceeds to step S45. If the check finds that it is not a valid authentication ticket ID or valid additional authentication ticket ID (NO at step S44), the document management service 40 brings the procedure to an end.

For example, the document management service 40 ascertains that the decryption of the ticket is successful if parameters contained in the ticket decrypting response received in step S43 includes “YES”, thereby determining that it is a valid authentication ticket ID or valid additional authentication ticket ID. If the parameters contained in the ticket decrypting response received in step S43 include “NO”, on the other hand, the document management service 40 ascertains that the decryption of the ticket has failed, thereby determining that it is not a valid authentication ticket ID or valid additional authentication ticket ID.

At step S45, the document management service 40 creates the session 80 including the decryption results (e.g., the authentication level and the like) included in the ticket decrypting response received in step S43.

Proceeding to step S46 following step S45, the document management service 40 creates a session start response inclusive of a session ID indicative of the session 80 created in step S45.

Proceeding to step S47 following step S46, the document management service 40 transmits the session start response created in step S46 to the client service 50 that is the source of request.

Through the processes as shown in FIG. 25, the document management service 40 creates the session 80 inclusive of the authentication level contained in the authentication ticket 60 or additional authentication ticket 70.

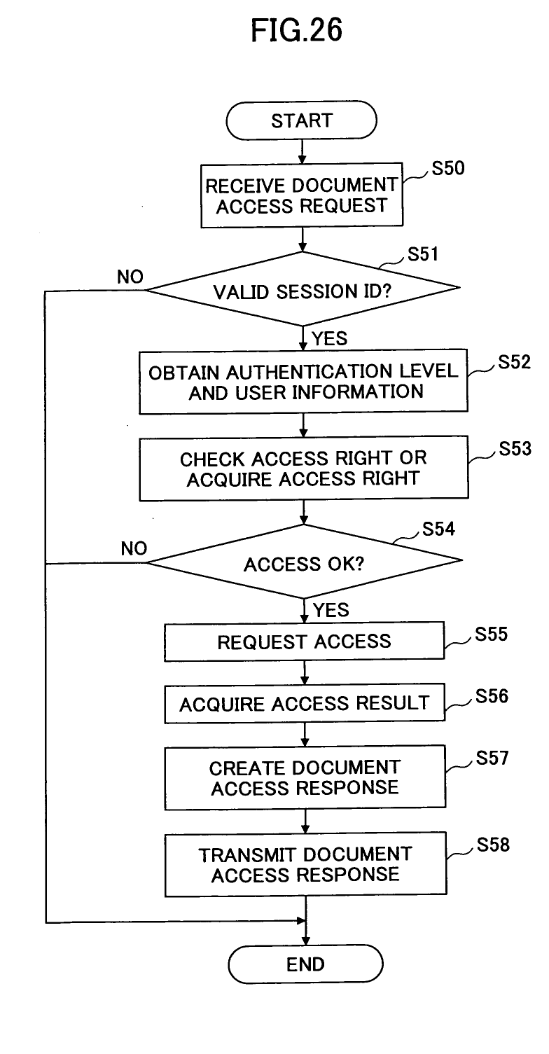

In the following, an example of the process relating to access to documents performed by the document management service 40 will be described with reference to FIG. 26. FIG. 26 is a flowchart showing an example of the process relating to access to documents performed by the document management service.

At step S50, the document management service 40 receives a document access request including a session ID, a document ID, and an access type (e.g., Read, Write, etc.), for example, transmitted from the client service 50.

Proceeding to step S51 following step S50, the document management service 40 checks whether the session ID contained in the document access request received in step S50 is a valid session ID. If the check finds that it is a valid session ID (YES at step S51), the document management service 40 proceeds to step S52. If the check finds that it is not a valid session ID (NO at step S51), the document management service 40 brings the procedure to an end.

For example, the document management service 40 checks based on the session ID contained in the document access request whether a corresponding valid session 80 exists, thereby determining whether it is a valid session ID.

Proceeding to step S52 following step S51, the document management service 40 acquires user information, an authentication level, etc. from the session 80 corresponding to the session ID contained in the document access request.

Proceeding to step S53 following step S52, the document management service 40 refers to the access-right managing table 90 in response to the user information and authentication level acquired in step S52 as well as the document ID contained in the document access request received in step S50, thereby checking information about access rights. Alternatively, the document management service 40 may acquire information about a relevant access right from the document management service 40 based on the user information and authentication level acquired in step S52 as well as the document ID contained in the document access request received in step S50.

Proceeding to step S54 following step S53, the document management service 40 determines based on the information about access rights checked in step S53 whether the requested document can be accessed with the requested access type. If access is possible (YES at step S54), the document management service 40 proceeds to step S55. If access is not possible (NO at step S54), the document management service 40 brings the procedure to an end. If the information about a relevant access right is acquired from the access-right managing table 90 at step S53, the document management service 40 determines based on the acquired information about a relevant access right and the access type contained in the document access request received in step S50 whether the requested document can be accessed with the requested access type.

At step S55, the document management service 40 requests to access the document identified by the document ID with the requested access type.

Proceeding to step S56 following step S55, the document management service 40 obtains access results.

Proceeding to step S57 following step S56, the document management service 40 creates a document access response including the access results obtained in step S56.

Proceeding to step S58 following step S57, the document management service 40 transmits the document access response created in step S57 to the client service 50 that is the source of the request.

Through the processes as shown in FIG. 26, the document management service 40 successfully processes the document access request in an efficient manner.

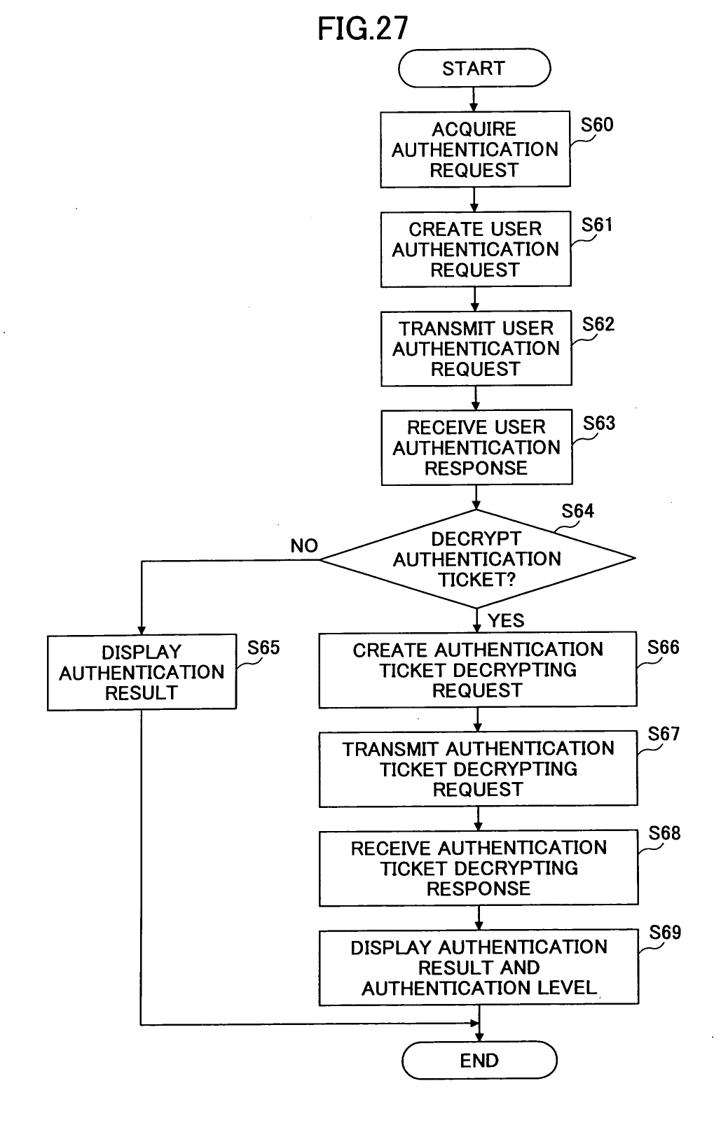

In the following, an example of the process relating to authentication and ticket decryption performed by the client service 50 will be described with reference to FIG. 27. FIG. 27 is a flowchart showing an example of the process relating to authentication and ticket decryption performed by the client service.

At step S60, the client service 50 receives an authentication request inclusive of authentication-related data (e.g., a user name, a password, the fingerprint data of an index finger) entered by the user.

Proceeding to step S61 following step S60, the client service 50 creates a user authentication request inclusive of the authentication-related data.

Proceeding to step S62 following step S61, the client service 50 transmits the user authentication request created in step S61 to the authentication service 30.

Proceeding to step S63 following step S62, the client service 50 receives a user authentication response inclusive of an authentication ticket ID from the authentication service 30 that is the recipient of the user authentication request transmitted in step S62.

Proceeding to step S64 following step S63, the client service 50 checks whether the decryption of the authentication ticket 60 is required. If the client service 50 determines that the decryption of the authentication ticket 60 is required (YES at step S64), the procedure goes to step S66. If it is determined that the decryption of the authentication ticket 60 is not required (NO at step S64), the procedure goes to step S65.

For example, the client service 50 refers to a definition file or the like stored in the HDD 39 or the like, and determines that the decryption of the authentication ticket 60 is required if the flag in the file indicates the need for the decryption of the authentication ticket 60.

At step S65, the client service 50 creates and displays a screen that shows the authentication results (e.g., an indication of a success of authentication).

At step S66, the client service 50 creates an authentication ticket decrypting request inclusive of the authentication ticket ID contained in the user authentication response received in step S63.

Proceeding to step S67 following step S66, the client service 50 transmits the authentication ticket decrypting request created in step S66 to the authentication service 30 that is the recipient of the user authentication request transmitted in step S62.

Proceeding to step S68 following step S67, the client service 50 receives an authentication ticket decrypting response from the authentication service 30 that is the recipient of the authentication ticket decrypting request transmitted in step S67.

Proceeding to step S69 following step S68, the client service 50 creates and displays a screen that shows authentication results (e.g., an indication of a success of authentication) and the authentication level and the like contained in the authentication ticket decrypting response received in step S68.

Through the processes as shown in FIG. 27, the client service 50 requests authentication, and creates the screen showing authentication results and/or an authentication level for display presentation.

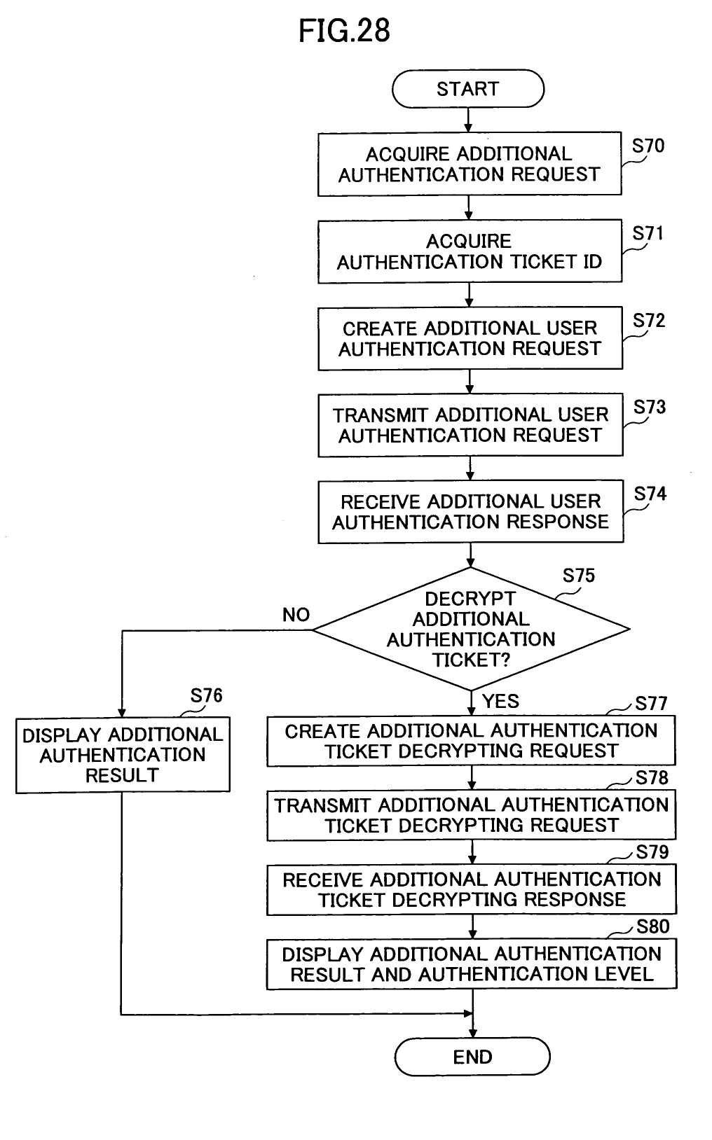

In the following, an example of the process relating to additional authentication and ticket decryption by the client service 50 will be described with reference to FIG. 28. FIG. 28 is a flowchart showing an example of the process relating to additional authentication and ticket decryption by the client service.

In step S70, the client service 50 acquires an additional authentication request inclusive of the additional-authentication-related data (e.g., the fingerprint data of ten fingers) entered by the user.

Proceeding to step S72 following step S71, the client service 50 acquires an authentication ticket ID corresponding to the above-noted authentication identifier.

Proceeding to step S73 following step S72, the client service 50 creates an additional user authentication request inclusive of the additional-authentication-related data and the authentication ticket ID acquired in step S71.

Proceeding to step S74 following step S73, the client service 50 transmits the additional user authentication request created in step S73 to a corresponding authentication service 30.

Proceeding to step S75 following step S74, the client service 50 receives an additional user authentication response inclusive of an additional authentication ticket ID from the authentication service 30 that is the recipient of the additional user authentication request transmitted in step S74.

Proceeding to step S75 following step S74, the client service 50 checks whether the decryption of the additional authentication ticket 70 is required. If it is ascertained that the decryption of the additional authentication ticket 70 is required (YES at step S75), the client service 50 proceeds to step S77. If it is ascertained that the decryption of the additional authentication ticket 70 is not necessary (NO at step S75), the client service 50 proceeds to step S76.

For example, the client service 50 refers to a definition file or the like stored in the HDD 39 or the like, and determines that the decryption of the additional authentication ticket 70 is required if the flag in the file indicates the need for the decryption of the additional authentication ticket 70.

At step S76, the client service 50 creates and displays a screen that shows the additional authentication results (e.g., an indication of a success of additional authentication).

At step S77, the client service 50 creates an additional authentication ticket decrypting request inclusive of the additional authentication ticket ID contained in the additional user authentication response received in step S74.

Proceeding to step S78 following step S77, the client service 50 transmits the additional authentication ticket decrypting request created in step S77 to the authentication service 30 that is the recipient of the additional user authentication request transmitted in step S73.

Proceeding to step S79 following step S78, the client service 50 receives an additional authentication ticket decrypting response from the authentication service 30 that is the recipient of the additional authentication ticket decrypting request transmitted in step S78.

Proceeding to step S80 following step S79, the client service 50 creates and displays a screen that shows additional authentication results (e.g., an indication of a success of additional authentication) and the authentication level and the like contained in the additional authentication ticket decrypting response received in step S79.

Through the processes as shown in FIG. 28, the client service 50 requests additional authentication, and creates the screen showing additional authentication results and/or an authentication level for display presentation.

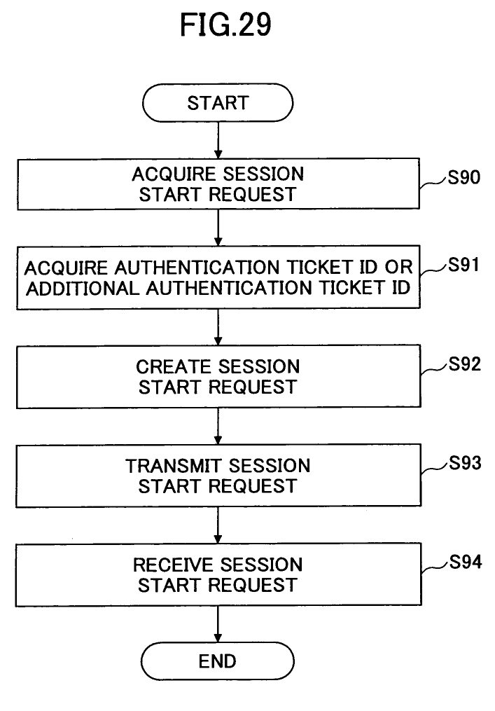

In the following, an example of the process relating to the start of a session performed by the client service 50 will be described with reference to FIG. 29. FIG. 29 is a flowchart showing an example of the process relating to the start of a session performed by the client service.

In step S90, the client service 50 obtains from the user a request for starting a session with the document management service 40.

Proceeding to step S91 following step S90, the client service 50 acquires a relevant authentication ticket ID or additional authentication ticket ID from the authentication ticket IDs or additional authentication ticket IDs kept in a management database of the client service 50.

Proceeding to step S92 following step S91, the client service 50 creates a session start request inclusive of the authentication ticket ID or additional authentication ticket ID acquired in step S91.

Proceeding to step S93 following step S92, the client service 50 transmits the session start request created in step S92 to a relevant document management service 40.

Proceeding to step S94 following step S93, the client service 50 receives a session start response inclusive of a session ID from the document management service 40 that is the recipient of the session start request transmitted in step S93.

Through the processes as shown in FIG. 29, the client service 50 establishes a session with the document management service 40 by use of the authentication ticket ID or additional authentication ticket ID.

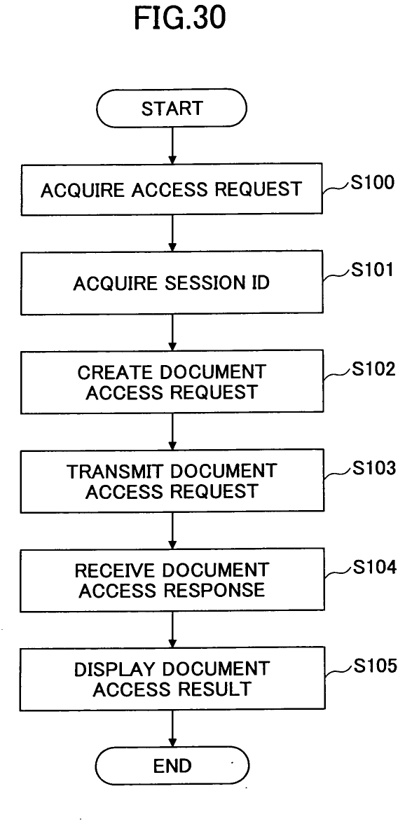

In the following, an example of the process relating to access to documents by the client service 50 will be described with reference to FIG. 30. FIG. 30 is a flowchart showing an example of the process relating to access to documents by the client service.

At step S100, the client service 50 receives a document access request inclusive of a document ID and access type (e.g., Read, Write, etc.) from the user.

Proceeding to step S101 following step S100, the client service 50 acquires a corresponding session ID from the session IDs kept in a management database of the client service 50.

Proceeding to step S102 following step S101, the client service 50 creates a document access request inclusive of the document ID and access type obtained in step S100 and the session ID obtained in step S101.

Proceeding to step S103 following step S102, the client service 50 transmits the document access request created in step S102 to a relevant document management service 40.

Proceeding to step S104 following step S103, the client service 50 receives a document access response including the results of access to the document from the document management service 40 that is the recipient of the document access request transmitted in step S103.

Proceeding to step S105 following step S104, the client service 50 creates and displays a screen that shows the results of access to the document contained in the document access response received in step S104.

Through the processes as shown in FIG. 30, the client service 50 accesses a document, and creates a screen including the access results for display presentation.

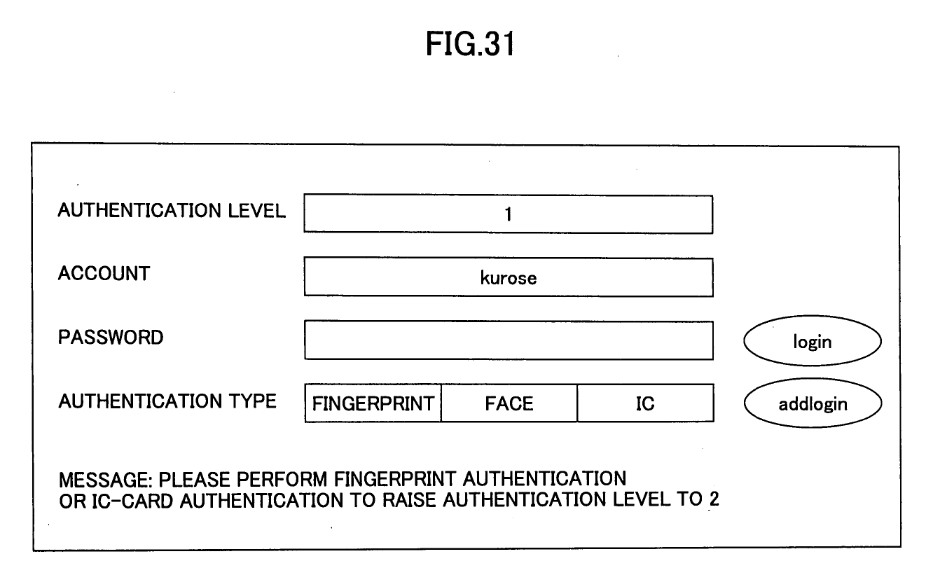

In the following, an example of the screen relating to authentication results displayed on the user terminal apparatus 3 will be described with reference to FIG. 31. FIG. 31 is an illustrative drawing for explaining an example of the screen relating to authentication results displayed on the user terminal apparatus.

As previously described, the display controlling unit 54 of the client service 50 creates and displays a screen that shows the results of user authentication and/or an authentication level, etc. The screen shown in FIG. 31 includes an indication of the authentication level “1” obtained as a result of authentication, and also includes a message indicative of a need for fingerprint authentication or IC-card authentication in order to obtain the authentication level “2”. Upon checking the screen, the user understands that fingerprint authentication or IC-card authentication is necessary in order to raise the authentication level by one.

### Embodiment 2

In the following, a second embodiment will be described, showing the functional configuration of the document management service 40 and the process relating to access to documents performed by the document management service 40.

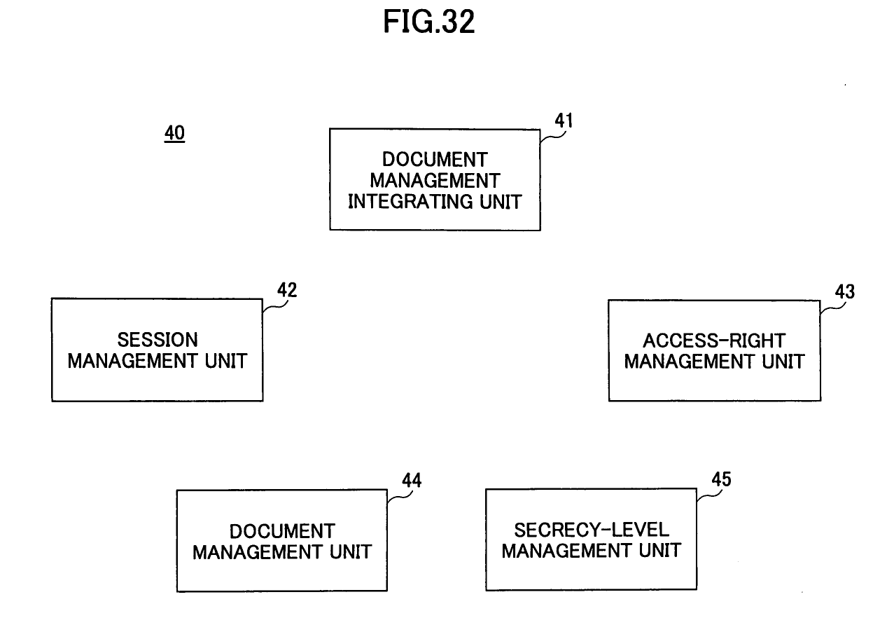

In the following, an example of the functional configuration of the document management service 40 will be described with reference to FIG. 32. FIG. 32 is a functional block diagrams showing an example of the document management service.

As shown in FIG. 32, the document management service 40 includes the document management integrating unit 41, the session management unit 42, the access-right management unit 43, the document management unit 44, and a secrecy-level management unit 45.

The document management integrating unit 41 serves as a module for controlling the overall operation of the document management service 40. The document management integrating unit 41 also serves to provide a common interface for the client service 50 and the authentication service 30.

The session management unit 42 serves as a module for managing the session 80.

The access-right management unit 43 serves as a module for managing the access-right managing table 90.

The document management unit 44 serves as a module for managing documents and a document attribute table 110, which will be described later.

The secrecy-level management unit 45 serves as a module for managing a secrecy level management table 100, which will be described later. The updating (or modification, etc.) of secrecy levels in the secrecy level management table 100 is performed by the secrecy-level management unit 45.

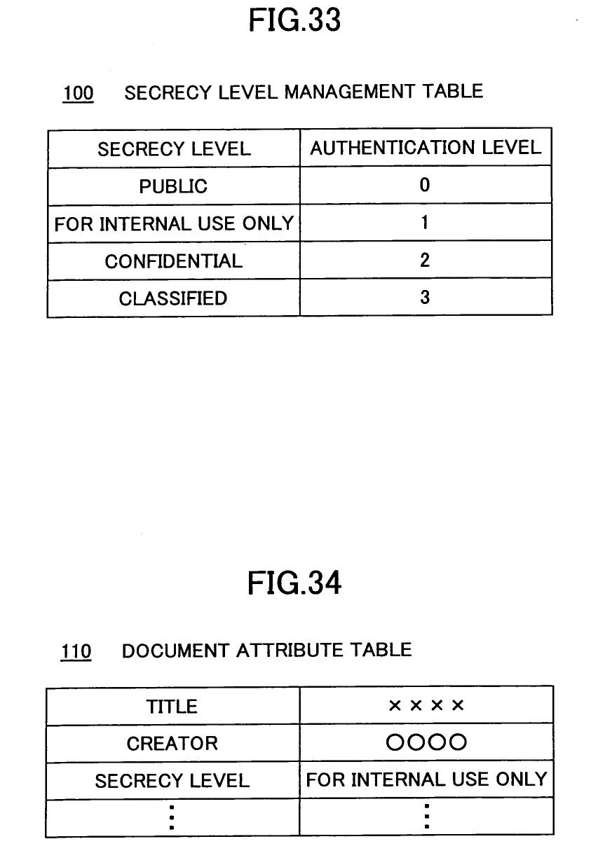

In the following, an example of the internal structure of the secrecy level management table 100 managed by the secrecy-level management unit 45 of the document management service 40 will be described with reference to FIG. 33. FIG. 33 is a diagram for explaining an example of the secrecy-level management table.

As shown in FIG. 33, the secrecy level management table 100 includes a secrecy level and an authentication level as entries.

The secrecy level stores secrecy levels. The authentication level stores authentication levels associated with the secrecy levels.

As shown in FIG. 33, an authentication level required for access is defined according to the secrecy level in the secrecy level management table 100. For example, the administrator or the like of the document management service 40 is able to change the security strength of documents by modifying the authentication level stored in the secrecy level management table 100, rather than modifying the secrecy level of every document in the document attribute table 110, which will be described later.

In the following, an example of the internal structure of the document attribute table 110 managed by the document management unit 44 of the document management service 40 will be described with reference to FIG. 34. FIG. 34 is a diagram for explaining an example of the document attribute table.

As shown in FIG. 34, the document attribute table 110 includes a title, a creator, and a secrecy level as entries.

The title entry stores the title. The creator entry stores the user ID of the document creator. The secrecy level entry stores the secrecy level of the document.

The document attribute table 110 as shown in FIG. 34 is provided for each document, and is matched with the document for management in the document management unit 44.

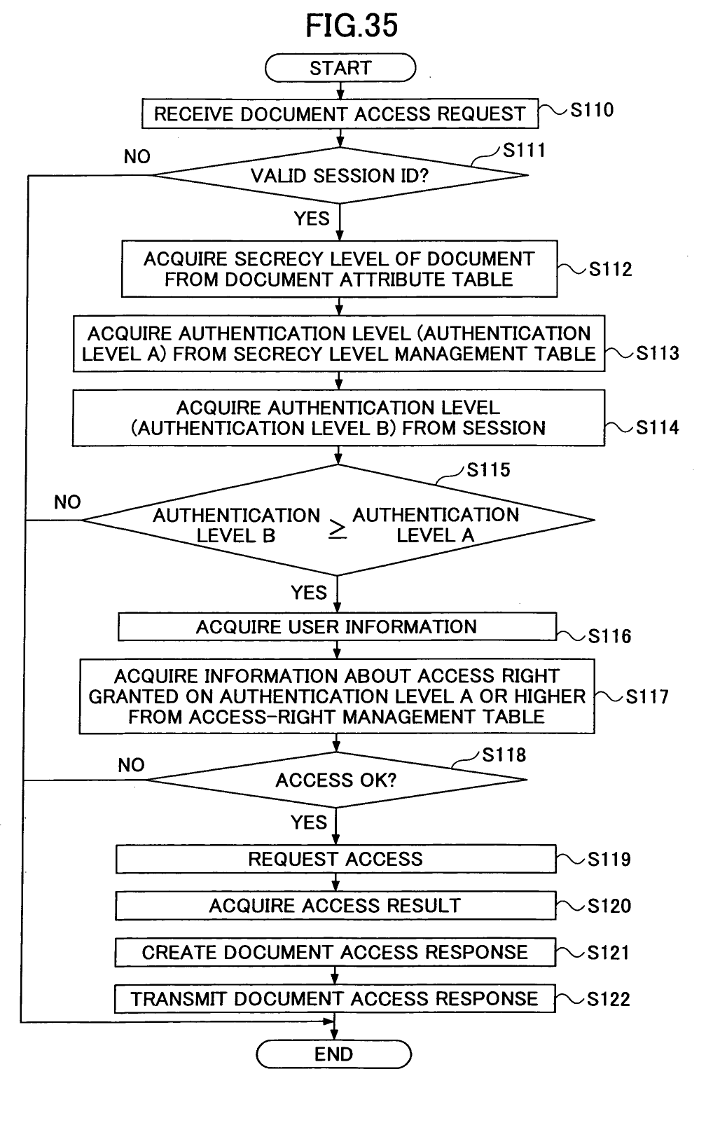

In the following, another example of the process relating to access to documents by the document management service 40 will be described with reference to FIG. 35. FIG. 35 is a flowchart showing an example of the process relating to access to documents by the document management service.

At step S110, the document management service 40 receives a document access request including a session ID, a document ID, and an access type (e.g., Read, Write, etc.), for example, transmitted from the client service 50.

Proceeding to step S111 following step S110, the document management service 40 checks whether the session ID contained in the document access request received in step S110 is a valid session ID. If it is found that the session ID is valid (YES at step S111), the document management service 40 proceeds to step S112. If it is found that the session ID is not valid (NO at step S111), the procedure comes to an end.

For example, the document management service 40 checks based on the session ID contained in the document access request whether a corresponding valid session 80 exists, thereby checking whether the session ID is valid.

“NO” at step S111 was described above as bringing the procedure to an end for the sake of simplicity of explanation. Alternatively, the document management service 40 may create a document access response including an error message indicative of an invalid session or the like for transmission to the client service 50 that is the source of the request.

At step S112, the document management service 40 acquires the secrecy level of the document from the document attribute table 110 based on the document ID contained in the document access request.

Proceeding to step S113 following step S112, the document management service 40 acquires a corresponding authentication level (authentication level A) from the secrecy level management table 100 in response to the secrecy level of the document acquired in step S112.

Proceeding to step S114 following step S113, the document management service 40 acquires an authentication level (authentication level B) from the session 80 corresponding to the session ID contained in the document access request. The process of step S114 may alternatively be performed before the process of step S112.

Proceeding to step S115 following step S114, the document management service 40 compares the authentication level A with the authentication level B, thereby checking whether the authentication level B is above the authentication level A. If the document management service 40 finds that the authentication level B is above the authentication level A (YES at step S115), the procedure goes to step S116. If it is found that the authentication level B is not above the authentication level A (NO at step S115), the procedure comes to an end. “NO” at step S115 is described here as bringing the procedure to an end for the sake of simplicity of explanation. Alternatively, the document management service 40 may create a document access response inclusive of an error message indicative of an insufficient authentication level for transmission to the client service 50 that is the source of the request.

At step S116, the document management service 40 acquires user information from the session 80 corresponding to the session ID contained in the document access request. The process of step S116 may be performed anywhere between step S111 and step S115.

Proceeding to step S117 following step S116, the document management service 40 refers to the access-right managing table 90 based on the document ID contained in the document access request received in step S110, the authentication level (authentication level A) acquired in step S113, and the user information acquired in step S116, thereby obtaining information about the access right that is granted to the authentication level A or above.

For example, the document management service 40 refers to the access-right managing table 90, and may find that the authentication level “1” allows Read access to the document. If the authentication level A is “2”, however, the document management service 40 obtains information about the access right that is granted to the authentication level “2” or higher.

Proceeding to step S118 following step S117, the document management service 40 checks based on the information about the access right obtained in step S117 whether the requested document can be accessed with the requested access type. If the document management service 40 ascertains that such access is possible (YES at step S118), the procedure proceeds to step S119. If the document management service 40 ascertains that such access is not possible (NO at step S118), the procedure comes to an end. “NO” at step S118 is described here as bringing the procedure to an end. Alternatively, the document management service 40 may create a document access response inclusive of an error message indicative of an access failure or the like for transmission to the client service 50 that is the source of the request.

At step S119, the document management service 40 requests to access the document corresponding to the document ID with the requested access type.

Proceeding to step S120 following step S119, the document management service 40 acquires an access result.

Proceeding to step S121 following step S120, the document management service 40 creates a document access response including the access result acquired in step S120.

Proceeding to step S122 following step S121, the document management service 40 transmits the document access response created in step S121 to the client service 50 that is the source of the request.

Through the processes as shown in FIG. 35, the document management service 40 processes a document access request properly in an efficient manner.

The present invention as described above makes it possible to effectively manage information about access rights regarding the objects provided by a Web service.

The preferred embodiments of the present invention have been described heretofore. The present invention is not limited to these embodiments, but various variations and modifications may be made without departing from the scope of the present invention.

For example, in these embodiments, an authentication ticket ID or additional authentication ticket ID is exchanged between the authentication service providing server 1, the user terminal apparatus 3, and the Web service providing server 2. In place of the authentication ticket ID or additional authentication ticket ID, the authentication ticket 60 or additional authentication ticket 70 may be exchanged, or a portion of the authentication ticket 60 or additional authentication ticket 70 may be exchanged. Furthermore, such exchanged information may be encrypted.

According to at least one embodiment of the invention, the invention provides an apparatus for providing an authentication service, including an authentication service providing unit. The authentication service providing unit includes an authentication level calculating unit configured to calculate an authentication level indicative of strength of authentication, and a user authentication information managing unit configured to manage user authentication information relating to user authentication associated with the authentication level calculated by the authentication level calculating unit.

The authentication service providing apparatus corresponds to the authentication service providing server 1, for example. Moreover, an authentication service providing unit corresponds to the authentication service 30, for example. Moreover, the authentication level calculating unit corresponds to the authentication level calculating unit 32, for example. Moreover, the user authentication information managing unit corresponds to the ticket management unit 33, for example. Moreover, the user authentication information corresponds to the authentication ticket 60, for example.

Further, at least one embodiment of the present invention provides an apparatus for providing a Web service including a Web service providing unit. The Web service providing unit includes an access-right managing unit configured to manage access-right management data that includes a user identifier indicative of a user, an authentication level indicative of strength of authentication, an object identifier indicative of an object provided by the Web service providing unit, and information about an access right regarding the object.

The Web service providing apparatus corresponds to the Web service providing server 2, for example. Moreover, the Web service providing unit corresponds to the document management service 40, for example. Moreover, access-right management data corresponds to access-right managing table 90, for example. Moreover, the access-right managing unit corresponds to the access-right management unit 43, for example.

Further, at least one embodiment of the present invention provides a user terminal apparatus for utilizing a Web service, including a Web service utilizing unit. The Web service utilizing unit includes a user authentication information managing unit configured to manage one of user authentication information relating to user authentication and a user authentication information identifier indicative of the user authentication information, and a display unit configured to display an authentication result of the user authentication and/or an authentication level indicative of strength of authentication associated with said user authentication information.

The user terminal apparatus corresponds to the user terminal apparatus 3, for example. Moreover, the Web service utilizing unit corresponds to the client service 50, for example. Moreover, the user authentication information managing unit corresponds to the ticket ID management unit 52, for example. Moreover, the display unit corresponds to the display controlling unit 54, for example.

Further, at least one embodiment of the present invention provides a method of providing an authentication service, including a user authentication request receiving step of receiving a user authentication request from an Web service utilizing unit that uses a Web service, a first authentication level calculating step of calculating an authentication level indicative of strength of authentication, and a user authentication information creating step of creating user authentication information relating to user authentication associated with the authentication level calculated by said first authentication level calculating step.

The user authentication request receiving step corresponds to step S10, for example. Moreover, the first authentication level calculating step corresponds to step S14, for example. Moreover, a user authentication information creating step corresponds to step S15, for example.

Further, at least one embodiment of the present invention provides a method of providing a Web service, including an access request receiving step of receiving a request for accessing an object from a Web service utilizing unit that uses the Web service, said request including an object identifier indicative of an object provided by a Web service providing unit and an access type indicative of a requested access type, a user identifier acquiring step of acquiring a user identifier indicative of a user, a first authentication level acquiring step of acquiring an authentication level indicative of strength of authentication, an access-right acquiring step of acquiring information about an access right regarding an object from access-right management data including the user identifier, the authentication level, the object identifier, the information about an access right regarding the object in response to in response to the object identifier, the user identifier, an authentication level indicative of strength of authentication, and an access checking step of checking based on the access type and the information about the access right acquired at the access-right acquiring step whether a requested document can be accessed.

The access request receiving step corresponds to step S50 or step S110, for example. Moreover, the user identifier acquiring step corresponds to part of step S52 or to step S116, for example. Moreover, the first authentication level acquiring step corresponds to part of step S52 or to step S114, for example. Moreover, the access-right acquiring step corresponds to step S53 or step S117, for example. Moreover, the access checking step corresponds to step S54 or step S118, for example. Moreover, the second authentication level acquiring step corresponds to step S113, for example.

Further, at least one embodiment of the present invention provides a method of utilizing a Web service, including a user authentication request transmitting step of transmitting a user authentication request to an authentication service providing unit that provides an authentication service, a user authentication information receiving step of receiving user authentication information relating to user authentication associated with an authentication level indicative of strength of authentication calculated by said authentication service providing unit or receiving a user authentication information identifier indicative of the user authentication information, and a user authentication result displaying step of displaying an authentication result of the user authentication.

The user authentication request transmitting step corresponds to step S62, for example. Moreover, the user authentication information receiving step corresponds to step S63, for example. Moreover, the user authentication result displaying step corresponds to step S65, for example.

The present application is based on Japanese priority applications No. 2003-382760 filed on Nov. 12, 2003 and No. 2004-319692 filed on Nov. 2, 2004, with the Japanese Patent Office, the entire contents of which are hereby incorporated by reference.

1. An apparatus for providing an authentication service, comprising an authentication service providing unit which includes:
an authentication level calculating unit configured to calculate an authentication level indicative of strength of authentication; and
a user authentication information managing unit configured to manage user authentication information relating to user authentication associated with the authentication level calculated by said authentication level calculating unit.

2. The apparatus as claimed in claim 1, wherein said user authentication information managing unit is further configured to manage additional user authentication information relating to additional user authentication associated with the authentication level newly calculated by said authentication level calculating unit.

3. The apparatus as claimed in claim 1, wherein said authentication level calculating unit obtains as the calculated authentication level a strongest authentication level among one or more authentication levels of one or more authentication systems that perform authentication.

4. The apparatus as claimed in claim 1, wherein said authentication level calculating unit obtains as the calculated authentication level a sum of one or more authentication levels of one or more authentication systems that perform authentication.

5. The apparatus as claimed in claim 1, wherein said authentication level calculating unit classifies one or more authentication systems that perform authentication into categories, and obtains as the calculated authentication level a sum of authentication levels each of which is strongest in a corresponding one of the categories.

6. An apparatus for providing a Web service, comprising a Web service providing unit which includes an access-right managing unit configured to manage access-right management data that includes a user identifier indicative of a user, an authentication level indicative of strength of authentication, an object identifier indicative of an object provided by the Web service providing unit, and information about an access right regarding the object.

7. The apparatus as claimed in claim 6, wherein said access-right managing unit is configured to search in said access-right management data in response to a request for obtaining information about access right including the user identifier, the object identifier, and the authentication level, thereby returning the information about the access right.

8. The apparatus as claimed in claim 6, wherein said Web service providing unit further includes a session management unit configured to manage a session with a Web service utilizing unit that uses the Web service, said session management unit holding a user identifier indicative of a user and an authentication level indicative of strength of authentication associated with each other during a period in which the session is effective.

9. The apparatus as claimed in claim 6, wherein said Web service providing unit further includes a secrecy level management unit configured to manage a secrecy level of the object, said secrecy level being associated with the authentication level.

10. The apparatus as claimed in claim 9, wherein said Web service providing unit further includes an object management unit configured to manage the object with associated attribute, said attribute including the secrecy level of the object.

11. A user terminal apparatus for utilizing a Web service, comprising a Web service utilizing unit which includes:
a user authentication information managing unit configured to manage one of user authentication information relating to user authentication and a user authentication information identifier indicative of the user authentication information; and
a display unit configured to display an authentication result of the user authentication and/or an authentication level indicative of strength of authentication associated with said user authentication information.

12. The user terminal apparatus as claimed in claim 11, wherein said user authentication information managing unit is further configured to manage additional user authentication information relating to additional user authentication or an additional user authentication information identifier indicative of the additional user authentication information.

13. The user terminal apparatus as claimed in claim 12, wherein said display unit is further configured to display an authentication result of the additional user authentication and/or an authentication level indicative of strength of authentication associated with said additional user authentication information.

14. A method of providing an authentication service, comprising:
a user authentication request receiving step of receiving a user authentication request from an Web service utilizing unit that uses a Web service:
a first authentication level calculating step of calculating an authentication level indicative of strength of authentication; and
a user authentication information creating step of creating user authentication information relating to user authentication associated with the authentication level calculated by said first authentication level calculating step.

15. The method as claimed in claim 14, further comprising a user authentication information transmitting step of transmitting the user authentication information created by said user authentication information creating step or a user authentication information identifier indicative of the user authentication information to the Web service utilizing unit.

16. The method as claimed in claim 14, further comprising:
an additional user authentication request receiving step of receiving an additional user authentication request inclusive of the user authentication information or a user authentication information identifier indicative of the user authentication information from the Web service utilizing unit:
a second authentication level calculating step of newly calculating an authentication level indicative of strength of authentication in response to the additional user authentication request; and
an additional user authentication information creating step of creating additional user authentication information associated with the authentication level calculated by said second authentication level calculating step.

17. The method as claimed in claim 16, further comprising an additional user authentication information transmitting step of transmitting the additional user authentication information created by said additional user authentication information creating step or an additional user authentication information identifier indicative of the additional user authentication information to the Web service utilizing unit.

18. The method as claimed in claim 14, further comprising:
a decrypting request receiving step of receiving a request for decrypting the user authentication information or additional user authentication information including the user authentication information relating to user authentication or a user authentication information identifier indicative of the user authentication information or additional user authentication information relating to additional user authentication or an additional user authentication information identifier indicative of the additional user authentication information from the Web service utilizing unit that uses the Web service or from a Web service providing unit that provides the Web service;
a decrypting step of decrypting the user authentication information or additional user authentication information; and
a decrypting result transmitting step of transmitting a decryption result inclusive of an authentication level indicative of strength of authentication associated with the user authentication information or additional user authentication information to the Web service providing unit or the Web service utilizing unit.

19. A method of providing a Web service, comprising:
an access request receiving step of receiving a request for accessing an object from a Web service utilizing unit that uses the Web service, said request including an object identifier indicative of an object provided by a Web service providing unit and an access type indicative of a requested access type;
a user identifier acquiring step of acquiring a user identifier indicative of a user;
a first authentication level acquiring step of acquiring an authentication level indicative of strength of authentication;
an access-right acquiring step of acquiring information about an access right regarding an object from access-right management data including the user identifier, the authentication level, the object identifier, the information about an access right regarding the object in response to in response to the object identifier, the user identifier, an authentication level indicative of strength of authentication; and
an access checking step of checking based on the access type and the information about the access right acquired at the access-right acquiring step whether a requested document can be accessed.

20. The method as claimed in claim 19, further comprising:
a secrecy level acquiring step of acquiring a secrecy level relating to a corresponding object based on the object identifier;
a second authentication level acquiring step of acquiring a corresponding authentication level based on the secrecy level acquired at said secrecy level acquiring step; and
an authentication level comparing step of comparing the authentication level acquired by said authentication level acquiring step with the authentication level acquired by said first authentication level acquiring step.

21. The method as claimed in claim 19, comprising:
a session start request receiving step of receiving a request for starting a session including user authentication information relating to user authentication or a user authentication information identifier indicative of the user authentication information or additional user authentication information relating to additional user authentication or an additional user authentication information identifier indicative of the additional user authentication information from the Web service utilizing unit that uses the Web service;
a decrypting request transmitting step of transmitting to an authentication service providing unit providing an authentication service a request for decrypting the user authentication information or additional user authentication information including the user authentication information or the user authentication information identifier or the additional user authentication information or the additional user authentication information identifier; and
a decryption result receiving step of receiving a decryption result inclusive of an authentication level indicative of strength of authentication from the authentication service providing unit.

22. A method of utilizing a Web service, comprising:
a user authentication request transmitting step of transmitting a user authentication request to an authentication service providing unit that provides an authentication service;
a user authentication information receiving step of receiving user authentication information relating to user authentication associated with an authentication level indicative of strength of authentication calculated by said authentication service providing unit or receiving a user authentication information identifier indicative of the user authentication information; and
a user authentication result displaying step of displaying an authentication result of the user authentication.

23. The method as claimed in claim 22, further comprising:
an additional user authentication request transmitting step of transmitting an additional user authentication request including the user authentication information or the user authentication information identifier to the authentication service providing unit;
an additional user authentication information receiving step of receiving additional user authentication information relating to additional user authentication associated with an authentication level indicative of strength of authentication newly calculated by said authentication service providing unit or receiving an additional user authentication information identifier indicative of the additional user authentication information; and
an additional user authentication result displaying step of displaying an authentication result of the additional user authentication.

24. The method as claimed in claim 22, further comprising:
a decrypting request transmitting step of transmitting to the authentication service providing unit a request for decrypting the user authentication information or additional user authentication information including the user authentication information relating to user authentication or a user authentication information identifier indicative of the user authentication information or additional user authentication information relating to additional user authentication or an additional user authentication information identifier indicative of the additional user authentication information;
a decrypting result receiving step of receiving a decryption result inclusive of an authentication level indicative of strength of authentication associated with the user authentication information or additional user authentication information; and
a decrypting result displaying step of displaying the decrypting result inclusive of the authentication level.

25. The method as claimed in claim 22, further comprising a session start request transmitting step of transmitting to a Web service providing unit providing a Web service a request for session start including user authentication information relating to user authentication or a user authentication information identifier indicative of the user authentication information or additional user authentication information relating to additional user authentication or an additional user authentication information identifier indicative of the additional user authentication information.

26. A program for causing a computer to perform the method of providing an authentication service as claimed in claim 14.

27. A program for causing a computer to perform the method of providing a Web service as claimed in claim 19.

28. A program for causing a computer to perform the method of utilizing a Web service as claimed in claim 22.

29. A computer-readable medium having a program embodied therein, said program causing a computer to perform the method of providing an authentication service as claimed in claim 14.

30. A computer-readable medium having a program embodied therein, said program causing a computer to perform the method of providing a Web service as claimed in claim 19.

31. A computer-readable medium having a program embodied therein, said program causing a computer to perform the method of utilizing a Web service as claimed in claim 22.
